(19) United States
(12) Patent Application Publication
(10) Pub. No.: US 2025/0094735 A1
(43) Pub. Date: Mar. 20, 2025

(54) DETECTION AND HANDLING OF ERRORS IN INPUT AND OUTPUT TO AND FROM A LARGE LANGUAGE MODEL

(71) Applicant: Oracle International Corporation, Redwood Shores, CA (US)

(72) Inventors: Amitabh Saikia, Mountain View, CA (US); Steven Martijn Davelaar, Utrecht (NL)

(73) Assignee: Oracle International Corporation, Redwood Shores, CA (US)

(21) Appl. No.: 18/885,507

(22) Filed: Sep. 13, 2024

Related U.S. Application Data
(60) Provisional application No. 63/583,159, filed on Sep. 15, 2023.
(60) Provisional application No. 63/583,160, filed on Sep. 15, 2023.
(60) Provisional application No. 63/583,164, filed on Sep. 15, 2023.

(51) Int. Cl. G06F 40/40

(52) U.S. Cl. CPC G06F 40/40

(57) ABSTRACT

Techniques for enhanced chatbot interaction using various large language model providers are provided. In one aspect, a method may include generating a request payload having a common request body specification based on an utterance such that the common request body specification may be a standardized data input format used by a generative artificial intelligence (GenAI) interface for interacting with GenAI model providers. In various embodiments, the method may include converting the common request body specification into a custom request body specification having a data input format associated with a GenAI model provider selected from the plurality of GenAI model providers, communicating, by the GenAI interface, the request payload with the custom request body specification to the GenAI provider for processing by a GenAI model, receiving, at the GenAI interface from the GenAI model provider, a response payload associated with: (i) an error, (ii) processing the request payload, or (iii) both.

### CROSS-REFERENCE TO RELATED APPLICATIONS

The present application is a non-provisional application of and claims the benefit and priority under 35 U.S.C. 119(e) of U.S. Provisional Application Nos. 63/583,159, 63/583,160, and 63/583,164, filed on Sep. 15, 2023, the entire contents of which are incorporated herein by reference for all purposes.

### FIELD

The present disclosure relates generally to artificial intelligence techniques, and more particularly, to techniques for detection and handling of errors in input and output to and from a Large Language Model (LLM).

### BACKGROUND

Artificial intelligence has many applications. To illustrate, many users around the world are on instant messaging or chat platforms in order to get instant reaction. Organizations often use these instant messaging or chat platforms to engage with customers (or end users) in live conversations. However, it can be very costly for organizations to employ service people to engage in live communication with customers or end users. Chatbots or bots have begun to be developed to simulate conversations with end users, especially over the Internet. End users can communicate with bots through messaging apps that the end users have already installed and used. An intelligent bot, generally powered by artificial intelligence (AI), can communicate more intelligently and contextually in live conversations, and thus may allow for a more natural conversation between the bot and the end users for improved conversational experience. Instead of the end user learning a fixed set of keywords or commands that the bot knows how to respond to, an intelligent bot may be able to understand the end user's intention based upon user utterances in natural language and respond accordingly.

However, artificial intelligence-based solutions, such as chatbots, can be difficult to build because many automated solutions require specific knowledge in certain fields and the application of certain techniques that may be solely within the capabilities of specialized developers. To illustrate, as part of building such chatbots, a developer may first understand the needs of enterprises and end users. The developer may then analyze and make decisions related to, for example, selecting data sets to be used for the analysis, preparing the input data sets for analysis (e.g., cleansing the data, extracting, formatting, and/or transforming the data prior to analysis, performing data features engineering, etc.), identifying an appropriate machine learning (ML) technique(s) or model(s) for performing the analysis, and improving the technique or model to improve results/outcomes based upon feedback. The task of identifying an appropriate model may include developing multiple models, possibly in parallel, iteratively testing and experimenting with these models, before identifying a particular model (or models) for use. Further, supervised learning-based solutions typically involve a training phase, followed by an application (i.e., inference) phase, and iterative loops between the training phase and the application phase. The developer may be responsible for carefully implementing and monitoring these phases to achieve optimal solutions.

### BRIEF SUMMARY

In various embodiments, a computer-implemented method may include generating a request payload having a common request body specification based on an utterance such that the common request body specification may be a standardized data input format used by a generative artificial intelligence (GenAI) interface for interacting with a plurality of GenAI model providers. In various embodiments, the method may include converting the common request body specification into a custom request body specification having a data input format associated with a GenAI model provider selected from the plurality of GenAI model providers, communicating, by the GenAI interface, the request payload with the custom request body specification to the GenAI provider for processing by a GenAI model, receiving, at the GenAI interface from the GenAI model provider, a response payload associated with: (i) an error, (ii) processing the request payload, or (iii) both, and may include generating a custom response body specification associated with the response payload such that the custom response body specification may have a data output format associated with the GenAI model provider. In various embodiments, the method may include converting the custom response body specification into a common response body specification, such that the common response body specification may be a standardized data output format used by the GenAI interface for interacting with the plurality of GenAI model providers, and may include determining whether the response payload includes an error or invalid data based on an evaluation of the common response body specification, and responsive to determining whether the response payload includes an error or invalid data, (i) executing one or more actions for handling the error or invalid data when the response payload includes the error or invalid data, or (ii) executing one or more other actions for processing the response payload when the response payload does not include the error or invalid data.

In some embodiments, determining whether the response payload includes an error or invalid data may include generating, by another artificial intelligence model, information concerning presence or absence of the error or invalid data within the common response body specification, such that the generating may be performed by: (i) retrieving information from one or more authoritative external sources to confirm accuracy of the response payload, (ii) assessing whether the response maintains contextual integrity, ensuring that the response payload may be appropriate and relevant within a given context, (iii) identifying errors or inconsistencies in the response payload based on a list of errors or inconsistencies, (iv) generating a reasoning chain or step-by-step explanation and validating whether the response payload follows the reasoning or explanation, or any combination thereof.

In some embodiments, determining whether the response payload includes an error or invalid data may include comparing values for entities with data in the response payload, evaluating, based on the comparing, whether there any missing matches between the values for the entities and the data in the response payload, and responsive to determining there are missing matches, determining whether the missing matches are indicative of the error or invalid data.

In some embodiments, executing the one or more actions may include modifying the request payload based on the error or invalid data to generate a modified request payload, such that the modified request payload includes an instruction that informs the GenAI model provider, the GenAI model, or both of the missing matches and requests that the GenAI model provider, the GenAI model, or both to revise the response payload to include the values for the entities associated with missing matches, and communicating the modified request payload to the GenAI model provider for processing by the GenAI model.

In some embodiments, the computer-implemented method further includes determining whether the request payload includes an error or invalid data based on an evaluation of the common request body specification, and responsive to determining whether the request payload includes an error or invalid data, (i) executing one or more actions for handling the error or invalid data when the request payload includes the error or invalid data, or (ii) converting the common request body specification into the custom request body when the request payload does not include the error or invalid data.

In some embodiments, executing the one or more actions may include modifying the request payload based on the error or invalid data to generate a modified request payload, such that the modified request payload includes an instruction that informs the GenAI model provider, the GenAI model, or both of the error or invalid data and requests that the GenAI model provider, the GenAI model, or both correct the error or invalid data, and communicating the modified request payload to the GenAI model provider for processing by the GenAI model.

In some embodiments, executing the one or more actions may include modifying the response payload based on the error or invalid data to generate a modified response payload, wherein the modified response payload includes and instruction that informs the GenAI model provider, the GenAI model, or both of the error or invalid data and requests that the GenAI model provider, the GenAI model, or both correct the error or invalid data, and communicating the modified prompt to the GenAI model provider for processing by the GenAI model.

In various embodiments, generating the request payload having the common request body specification may include representing the utterance as one or more messages based on JavaScript object syntax (JSON); and generating the custom response body specification associated with the response payload, comprises representing the response payload as one or more candidate messages or a set of candidate messages based on JSON.

In some embodiments, a system is provided that includes one or more processors and one or more computer-readable media storing instructions which, when executed by the one or more processors, cause the system to perform part or all of the operations and/or methods disclosed herein.

In some embodiments, one or more non-transitory computer-readable media are provided for storing instructions which, when executed by one or more processors, cause a system to perform part or all of the operations and/or methods disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

FIG. 1 is a simplified block diagram of a distributed environment incorporating an exemplary embodiment.

FIG. 2 is a simplified block diagram of a computing system implementing a master bot according to various embodiments.

FIG. 3 is a simplified block diagram of a computing system implementing a skill bot according to various embodiments.

FIG. 4 is an example simplified system architecture for enabling interaction of multiple users with a set of large language models (LLMs) in accordance with various embodiments.

FIG. 5 illustrates an example simplified generative artificial intelligence bot infrastructure for error detection and validating response and request payloads, in accordance with various embodiments.

FIG. 6 illustrates an example swim diagram for error and validation handling using a generative artificial intelligence interface, in accordance with various embodiments.

FIG. 7 illustrates an example simplified method for using a generative artificial intelligence interface, in accordance with various embodiments.

FIG. 8 is a block diagram illustrating one pattern for implementing a cloud infrastructure as a service system, according to at least one embodiment.

FIG. 9 is a block diagram illustrating another pattern for implementing a cloud infrastructure as a service system, according to at least one embodiment.

FIG. 10 is a block diagram illustrating another pattern for implementing a cloud infrastructure as a service system, according to at least one embodiment.

FIG. 11 is a block diagram illustrating another pattern for implementing a cloud infrastructure as a service system, according to at least one embodiment.

FIG. 12 is a block diagram illustrating an example computer system, according to at least one embodiment.

### DETAILED DESCRIPTION

In the following description, for the purposes of explanation, specific details are set forth in order to provide a thorough understanding of some embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

### Introduction

Artificial intelligence has many applications. For example, a digital assistant is an artificial intelligence-driven interface that helps users accomplish a variety of tasks using natural language conversations. For each digital assistant, a customer may assemble one or more skills. Skills (also described herein as chatbots, bots, or skill bots) are individual bots that are focused on specific types of tasks, such as tracking inventory, submitting timecards, and creating expense reports. When an end user engages with the digital assistant, the digital assistant evaluates the end user input and routes the conversation to and from the appropriate chatbot. The digital assistant can be made available to end users through a variety of channels such as FACEBOOK® Messenger, SKYPE MOBILE® messenger, or a Short Message Service (SMS). Channels carry the chat back and forth from end users on various messaging platforms to the digital assistant and its various chatbots. The channels may also support user agent escalation, event-initiated conversations, and testing.

Intents allow artificial intelligence-based technology such as a chatbot to understand what the user wants the chatbot to do. Intents are the user's intention communicated to the chatbot via user requests and statements, which are also referred to as utterances (e.g., get account balance, make a purchase, etc.). As used herein, an utterance or a message may refer to a set of words (e.g., one or more sentences) exchanged during a conversation with a chatbot. Intents may be created by providing a name that illustrates some user action (e.g., order a pizza) and compiling a set of real-life user statements, or utterances that are commonly associated with triggering the action. Because the chatbot's cognition is derived from these intents, each intent may be created from a data set that is robust (one to two dozen utterances) and varied, so that the chatbot may interpret ambiguous user input. A rich set of utterances enables a chatbot to understand what the user wants when it receives messages like “Forget this order!” or “Cancel delivery!”—messages that mean the same thing, but are expressed differently. Collectively, the intents, and the utterances that belong to them, make up a training corpus for the chatbot. By training a model with the corpus, a customer may essentially turn that model into a reference tool for resolving end user input to a single intent. A customer can improve the acuity of the chatbot's cognition through rounds of intent testing and intent training.

Once an intent of the user is understood by the chatbot, the chatbot can execute a dialog flow. A flow is a piece of the skill dialog flow that defines the interaction with the user to complete a task or a part of a task that the user wants to perform. Typical examples of flows include:
Intent-driven flows, where each intent defined in the skill has an associated flow, for example ‘Order Pizza’, ‘Send Money’ or ‘Create Expense’.
Supporting or utility flows for tasks like user authorization, new user onboarding, logging, or providing user assistance. Such flows can be invoked from multiple flows. For example, you could have a Create Account sub-flow that you invoke from flows like Order Pizza or Send Money.

Generally speaking, flows break down into the following types: Main Flow, Intent flows, Flows for built-in events and system transitions, and Sub-flows that can be used by top-level flows. The main flow isn't really a flow as such. Rather, it is the control center for the skill, from where users are directed to specialized flows that are mapped to the intents. Within the intent and sub-flows various actions may be defined for supporting what the user wants the chatbot to do in accordance with the understood intent. The various actions can include conversation dialogue, execution of queries on databases, sentiment analysis, data analysis, API and REST calls, and the like.

More recently, Large Language Models (LLMs) have been integrated into digital assistants to enhance skills with generative AI capabilities. These capabilities include handling small talk with a user, generating written summaries of data, automating challenging or repetitive business tasks, such as those required for talent acquisition, and providing sentiment analysis of a given piece of text to determine whether it reflects a positive, negative, or neutral opinion. Using the Invoke Large Language Model component (the LLM component), a skill bot developer can plug these capabilities into their dialog flow wherever they're needed. This dialog flow component is the primary integration piece for generative AI in that it contacts the LLM through a REST call, then sends the LLM a prompt (the natural language instructions to the LLM) along with related parameters. It then returns the results generated by the model (which are also known as completions) and manages the state of the LLM-user interactions so that its responses remain in context after successive rounds of user queries and feedback. The LLM component can call any LLM. A user can add one or more LLM component states (or LLM blocks) to flows. A user can also chain the LLM calls so that the output of one LLM request can be passed to a subsequent LLM request.

Nonetheless, when users interface with an LLM through the Invoke Large Language Model component, several challenges emerge in detecting and handling errors in both input (e.g., prompt from user and/or skill) and output (e.g., response from LLM in LLM service providers format). For example, the utterances provided to the chatbots from the users may not be appropriately relayed to the LLM thus creating complications by way of hallucinations, inaccurate responses, or similar deficiencies. In addition, the LLM outputs may be misinterpreted by conventional chatbots since the LLM may not provide the correct format for the response. These factors lead to exponential error propagation and lead to inefficient and challenging interactions with the user. More specifically, the variability in input and output from different users or LLM service providers complicates error detection, requiring sophisticated algorithms to handle diverse data effectively. Also, on the input and output side, handling errors necessitates real-time validation to maintain efficient interactions, which can be challenging due to the need for robust and scalable mechanisms that do not introduce significant latency. Furthermore, mitigating biases and ensuring fair and unbiased outputs across different contexts is important, requiring constant monitoring and adjustment to maintain the integrity and reliability of the LLM in a cloud service environment.

Accordingly, different approaches are needed to address these challenges and others. In accordance with various aspects of the present disclosure, input and output validation handlers are implemented to detect and handle errors and/or validations. A user or developer (e.g., skill bot developer) is able to set predefined criteria in a visual flow designer (VFD) LLM component and the results of criteria resolution will be passed into the input or output event handler for processing based on developer configurations. For example, the developer can choose to raise an error, transition to another state or, request clarification from the user, re-prompt the LLM to improve its response, and the like.

According to embodiments of the present disclosure, an enhanced chatbot system is implemented with the input and output validation handlers, which provides users and developers with flexibility when interacting with various LLM service providers. For example, a digital assistant (DA) chatbot system may receive an utterance from a user and identify via the flow that the utterance is outside a present scope of deterministic responses and instead is to be processed using probabilistic responses such as those generated by an LLM. The DA chatbot system may take the utterance and identify and select one or more LLM providers such as OpenAI™, Cohere™, etc. that may provide accurate and reliable probabilistic responses to the utterance. The DA chatbot system may format the utterance several times depending on how many different LLM providers have been selected by the DA chatbot system. The DA chatbot system may then review some or all of the responses from the LLM providers and select a proper response to provide to the user. In many cases, the responses may be reformatted into a standardized format so that the chatbot interaction remains fluid. In addition, the DA chatbot system may identify, using the input and output validation handlers, whether or not some or all of the utterances from users, prompts from users or the DA chatbot system, and/or responses from the LLM providers contains errors or invalid data. In these cases, the inputs and outputs associated with the errors may be identified such that the inputs and outputs may be re-evaluated or even re-run with the same or different LLM providers. The DA chatbot system of the present disclosure substantially improves the technical field of chatbot development and interaction by providing a flexible, enhanced, and responsive chatbot which handles increasingly complex and large utterances from users. Additionally, the responses may be filtered and selected for accuracy and precision, reducing the likelihood of hallucinations and inaccurate responses, and may be provided to the user in a clear and uniform manner.

In an exemplary embodiment, a computer-implemented method may include generating a request payload having a common request body specification based on an utterance such that the common request body specification may be a standardized data input format used by a generative artificial intelligence (GenAI) interface for interacting with a plurality of GenAI model providers. In various embodiments, the method may include converting the common request body specification into a custom request body specification having a data input format associated with a GenAI model provider selected from the plurality of GenAI model providers, communicating, by the GenAI interface, the request payload with the custom request body specification to the GenAI provider for processing by a GenAI model, receiving, at the GenAI interface from the GenAI model provider, a response payload associated with: (i) an error, (ii) processing the request payload, or (iii) both, and may include generating a custom response body specification associated with the response payload such that the custom response body specification may have a data output format associated with the GenAI model provider. In various embodiments, the method may include converting the custom response body specification into a common response body specification, such that the common response body specification may be a standardized data output format used by the GenAI interface for interacting with the plurality of GenAI model providers, and may include determining whether the response payload includes an error or invalid data based on an evaluation of the common response body specification, and responsive to determining whether the response payload includes an error or invalid data, (i) executing one or more actions for handling the error or invalid data when the response payload includes the error or invalid data, or (ii) executing one or more other actions for processing the response payload when the response payload does not include the error or invalid data.

As used herein, the articles ‘a’ and ‘an’ are used herein to refer to one or to more than one (i.e. at least one) of the grammatical object of the article. By way of example, an element means at least one element and can include more than one element.

As used herein, the terms “about,” “similarly,” “substantially,” and “approximately” are defined as being largely but not necessarily wholly what is specified (and include wholly what is specified) as understood by one of ordinary skill in the art. In any disclosed embodiment, the term “about,” “similarly,” “substantially,” or “approximately” may be substituted with “within [a percentage] of” what is specified, where the percentage includes 0.1 percent, 1 percent, 5 percent, and 10 percent, etc. Moreover, the term terms “about,” “similarly,” “substantially,” and “approximately” are used to provide flexibility to a numerical range endpoint by providing that a given value may be slightly above or slightly below the endpoint without affecting the desired result.

As used herein, when an action is “based on” something, this means the action can be based at least in part on at least a part of the something.

The use herein of the terms including, comprising, or having, and variations thereof, is meant to encompass the elements listed thereafter and equivalents thereof as well as additional elements. Embodiments recited as including, comprising, or having certain elements are also contemplated as consisting essentially of and consisting of those certain elements. As used herein, and/or, refers to and encompasses any and all possible combinations of one or more of the associated listed items, as well as the lack of combinations were interpreted in the alternative (or).

### Bot and Analytic Systems

A bot (also referred to as a skill, chatbot, chatterbot, or talkbot) is a computer program that can perform conversations with end users. The bot can generally respond to natural-language messages (e.g., questions or comments) through a messaging application that uses natural-language messages. Enterprises may use one or more bot systems to communicate with end users through a messaging application. The messaging application, which may be referred to as a channel, may be an end user preferred messaging application that the end user has already installed and familiar with. Thus, the end user does not need to download and install new applications in order to chat with the bot system. The messaging application may include, for example, over-the-top (OTT) messaging channels (such as Facebook Messenger, Facebook WhatsApp, WeChat, Line, Kik, Telegram, Talk, Skype, Slack, or SMS), virtual private assistants (such as Amazon Dot, Echo, or Show, Google Home, Apple HomePod, etc.), mobile and web app extensions that extend native or hybrid/responsive mobile apps or web applications with chat capabilities, or voice based input (such as devices or apps with interfaces that use Siri, Cortana, Google Voice, or other speech input for interaction).

In some examples, a bot system may be associated with a Uniform Resource Identifier (URI). The URI may identify the bot system using a string of characters. The URI may be used as a webhook for one or more messaging application systems. The URI may include, for example, a Uniform Resource Locator (URL) or a Uniform Resource Name (URN). The bot system may be designed to receive a message (e.g., a hypertext transfer protocol (HTTP) post call message) from a messaging application system. The HTTP post call message may be directed to the URI from the messaging application system. In some embodiments, the message may be different from a HTTP post call message. For example, the bot system may receive a message from a Short Message Service (SMS). While discussion herein may refer to communications that the bot system receives as a message, it should be understood that the message may be an HTTP post call message, a SMS message, or any other type of communication between two systems.

End users may interact with the bot system through a conversational interaction (sometimes referred to as a conversational user interface (UI)), just as interactions between people. In some cases, the interaction may include the end user saying “Hello” to the bot and the bot responding with a “Hi” and asking the end user how it can help. In some cases, the interaction may also be a transactional interaction with, for example, a banking bot, such as transferring money from one account to another; an informational interaction with, for example, a HR bot, such as checking for vacation balance; or an interaction with, for example, a retail bot, such as discussing returning purchased goods or seeking technical support.

In some embodiments, the bot system may intelligently handle end user interactions without interaction with an administrator or developer of the bot system. For example, an end user may send one or more messages to the bot system in order to achieve a desired goal. A message may include certain content, such as text, emojis, audio, image, video, or other method of conveying a message. In some embodiments, the bot system may convert the content into a standardized form (e.g., a representational state transfer (REST) call against enterprise services with the proper parameters) and generate a natural language response. The bot system may also prompt the end user for additional input parameters or request other additional information. In some embodiments, the bot system may also initiate communication with the end user, rather than passively responding to end user utterances. Described herein are various techniques for identifying an explicit invocation of a bot system and determining an input for the bot system being invoked. In some embodiments, explicit invocation analysis is performed by a master bot based on detecting an invocation name in an utterance. In response to detection of the invocation name, the utterance may be refined for input to a skill bot associated with the invocation name.

A conversation with a bot may follow a specific conversation flow including multiple states. The flow may define what would happen next based on an input. In some embodiments, a state machine that includes user defined states (e.g., end user intents) and actions to take in the states or from state to state may be used to implement the bot system. A conversation may take different paths based on the end user input, which may impact the decision the bot makes for the flow. For example, at each state, based on the end user input or utterances, the bot may determine the end user's intent in order to determine the appropriate next action to take. As used herein and in the context of an utterance, the term “intent” refers to an intent of the user who provided the utterance. For example, the user may intend to engage a bot in conversation for ordering pizza, so that the user's intent could be represented through the utterance “Order pizza.” A user intent can be directed to a particular task that the user wishes a chatbot to perform on behalf of the user. Therefore, utterances can be phrased as questions, commands, requests, and the like, that reflect the user's intent. An intent may include a goal that the end user would like to accomplish.

In the context of the configuration of a chatbot, the term “intent” is used herein to refer to configuration information for mapping a user's utterance to a specific task/action or category of task/action that the chatbot can perform. In order to distinguish between the intent of an utterance (i.e., a user intent) and the intent of a chatbot, the latter is sometimes referred to herein as a “bot intent.” A bot intent may comprise a set of one or more utterances associated with the intent. For instance, an intent for ordering pizza can be communicated by various permutations of utterances that express a desire to place an order for pizza. These associated utterances can be used to train an intent classifier of the chatbot to enable the intent classifier to subsequently determine whether an input utterance from a user matches the order pizza intent. A bot intent may be associated with one or more dialog flows for starting a conversation with the user and in a certain state. For example, the first message for the order pizza intent could be the question “What kind of pizza would you like?” In addition to associated utterances, a bot intent may further comprise named entities that relate to the intent. For example, the order pizza intent could include variables or parameters used to perform the task of ordering pizza, e.g., topping 1, topping 2, pizza type, pizza size, pizza quantity, and the like. The value of an entity is typically obtained through conversing with the user.

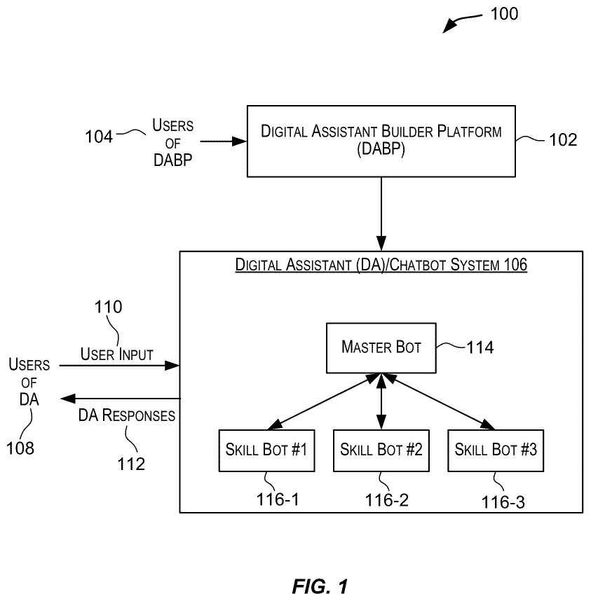

FIG. 1 is a simplified block diagram of an environment 100 incorporating a chatbot system according to some embodiments. Environment 100 comprises a digital assistant builder platform (DABP) 102 that enables users of DABP 102 to create and deploy digital assistants or chatbot systems. DABP 102 can be used to create one or more digital assistants (or DAs) or chatbot systems. For example, as shown in FIG. 1, user 104 representing a particular enterprise can use DABP 102 to create and deploy a digital assistant 106 for users of the particular enterprise. For example, DABP 102 can be used by a bank to create one or more digital assistants for use by the bank's customers. The same DABP 102 platform can be used by multiple enterprises to create digital assistants. As another example, an owner of a restaurant (e.g., a pizza shop) may use DABP 102 to create and deploy a digital assistant that enables customers of the restaurant to order food (e.g., order pizza).

For purposes of this disclosure, a “digital assistant” is an entity that helps users of the digital assistant accomplish various tasks through natural language conversations. A digital assistant can be implemented using software only (e.g., the digital assistant is a digital entity implemented using programs, code, or instructions executable by one or more processors), using hardware, or using a combination of hardware and software. A digital assistant can be embodied or implemented in various physical systems or devices, such as in a computer, a mobile phone, a watch, an appliance, a vehicle, and the like. A digital assistant is also sometimes referred to as a chatbot system. Accordingly, for purposes of this disclosure, the terms digital assistant and chatbot system are interchangeable.

A digital assistant, such as digital assistant 106 built using DABP 102, can be used to perform various tasks via natural language-based conversations between the digital assistant and its users 108. As part of a conversation, a user may provide one or more user inputs 110 to digital assistant 106 and get responses 112 back from digital assistant 106. A conversation can include one or more of inputs 110 and responses 112. Via these conversations, a user can request one or more tasks to be performed by the digital assistant and, in response, the digital assistant is configured to perform the user-requested tasks and respond with appropriate responses to the user.

User inputs 110 are generally in a natural language form and are referred to as utterances. A user utterance 110 can be in text form, such as when a user types in a sentence, a question, a text fragment, or even a single word and provides it as input to digital assistant 106. In some embodiments, a user utterance 110 can be in audio input or speech form, such as when a user says or speaks something that is provided as input to digital assistant 106. The utterances are typically in a language spoken by the user 108. For example, the utterances may be in English, or some other language. When an utterance is in speech form, the speech input is converted to text form utterances in that particular language and the text utterances are then processed by digital assistant 106. Various speech-to-text processing techniques may be used to convert a speech or audio input to a text utterance, which is then processed by digital assistant 106. In some embodiments, the speech-to-text conversion may be done by digital assistant 106 itself.

An utterance, which may be a text utterance or a speech utterance, can be a fragment, a sentence, multiple sentences, one or more words, one or more questions, combinations of the aforementioned types, and the like. Digital assistant 106 may be configured to apply natural language understanding (NLU) techniques to the utterance to understand the meaning of the user input. As part of the NLU processing for an utterance, digital assistant 106 may be configured to perform processing to understand the meaning of the utterance, which involves identifying one or more intents and one or more entities corresponding to the utterance. Upon understanding the meaning of an utterance, digital assistant 106 may perform one or more actions or operations responsive to the understood meaning or intents. For purposes of this disclosure, it is assumed that the utterances are text utterances that have been provided directly by a user 108 of digital assistant 106 or are the results of conversion of input speech utterances to text form. This however is not intended to be limiting or restrictive in any manner.

For example, a user 108 input may request a pizza to be ordered by providing an utterance such as “I want to order a pizza.” Upon receiving such an utterance, digital assistant 106 is configured to understand the meaning of the utterance and take appropriate actions. The appropriate actions may involve, for example, responding to the user with questions requesting user input on the type of pizza the user desires to order, the size of the pizza, any toppings for the pizza, and the like. The responses provided by digital assistant 106 may also be in natural language form and typically in the same language as the input utterance. As part of generating these responses, digital assistant 106 may perform natural language generation (NLG). For the user ordering a pizza, via the conversation between the user and digital assistant 106, the digital assistant may guide the user to provide all the requisite information for the pizza order, and then at the end of the conversation cause the pizza to be ordered. Digital assistant 106 may end the conversation by outputting information to the user indicating that the pizza has been ordered.

At a conceptual level, digital assistant 106 performs various processing in response to an utterance received from a user. In some embodiments, this processing involves a series or pipeline of processing steps including, for example, understanding the meaning of the input utterance (sometimes referred to as Natural Language Understanding (NLU), determining an action to be performed in response to the utterance, where appropriate causing the action to be performed, generating a response to be output to the user responsive to the user utterance, outputting the response to the user, and the like. The NLU processing can include parsing the received input utterance to understand the structure and meaning of the utterance, refining and reforming the utterance to develop a better understandable form (e.g., logical form) or structure for the utterance. Generating a response may include using NLG techniques.

The NLU processing performed by a digital assistant, such as digital assistant 106, can include various NLP related processing such as sentence parsing (e.g., tokenizing, lemmatizing, identifying part-of-speech tags for the sentence, identifying named entities in the sentence, generating dependency trees to represent the sentence structure, splitting a sentence into clauses, analyzing individual clauses, resolving anaphoras, performing chunking, and the like). In some embodiments, the NLU processing or portions thereof is performed by digital assistant 106 itself. In some other embodiments, digital assistant 106 may use other resources to perform portions of the NLU processing. For example, the syntax and structure of an input utterance sentence may be identified by processing the sentence using a parser, a part-of-speech tagger, and/or a named entity recognizer. In one implementation, for the English language, a parser, a part-of-speech tagger, and a named entity recognizer such as ones provided by the Stanford Natural Language Processing (NLP) Group are used for analyzing the sentence structure and syntax. These are provided as part of the Stanford CoreNLP toolkit.

While the various examples provided in this disclosure show utterances in the English language, this is meant only as an example. In some embodiments, digital assistant 106 is also capable of handling utterances in languages other than English. Digital assistant 106 may provide subsystems (e.g., components implementing NLU functionality) that are configured for performing processing for different languages. These subsystems may be implemented as pluggable units that can be called using service calls from an NLU core server. This makes the NLU processing flexible and extensible for each language, including allowing different orders of processing. A language pack may be provided for individual languages, where a language pack can register a list of subsystems that can be served from the NLU core server.

A digital assistant, such as digital assistant 106 depicted in FIG. 1, can be made available or accessible to its users 108 through a variety of different channels, such as but not limited to, via certain applications, via social media platforms, via various messaging services and applications, and other applications or channels. A single digital assistant can have several channels configured for it so that it can be run on and be accessed by different services simultaneously.

A digital assistant or chatbot system generally contains or is associated with one or more skills. In some embodiments, these skills are individual chatbots (referred to as skill bots) that are configured to interact with users and fulfill specific types of tasks, such as tracking inventory, submitting timecards, creating expense reports, ordering food, checking a bank account, making reservations, buying a widget, and the like. For example, for the embodiment depicted in FIG. 1, digital assistant or chatbot system 106 includes skills 116-1, 116-2, and so on. For purposes of this disclosure, the terms “skill” and “skills” are used synonymously with the terms “skill bot” and “skill bots”, respectively.

Each skill associated with a digital assistant helps a user of the digital assistant complete a task through a conversation with the user, where the conversation can include a combination of text or audio inputs provided by the user and responses provided by the skill bots. These responses may be in the form of text or audio messages to the user and/or using simple user interface elements (e.g., select lists) that are presented to the user for the user to make selections.

There are various ways in which a skill or skill bot can be associated or added to a digital assistant. In some instances, a skill bot can be developed by an enterprise and then added to a digital assistant using DABP 102. In other instances, a skill bot can be developed and created using DABP 102 and then added to a digital assistant created using DABP 102. In yet other instances, DABP 102 provides an online digital store (referred to as a “skills store”) that offers multiple skills directed to a wide range of tasks. The skills offered through the skills store may also expose various cloud services. In order to add a skill to a digital assistant being generated using DABP 102, a user of DABP 102 can access the skills store via DABP 102, select a desired skill, and indicate that the selected skill is to be added to the digital assistant created using DABP 102. A skill from the skills store can be added to a digital assistant as is or in a modified form (for example, a user of DABP 102 may select and clone a particular skill bot provided by the skills store, make customizations or modifications to the selected skill bot, and then add the modified skill bot to a digital assistant created using DABP 102).

Various different architectures may be used to implement a digital assistant or chatbot system. For example, in some embodiments, the digital assistants created and deployed using DABP 102 may be implemented using a master bot/child(or sub) bot paradigm or architecture. According to this paradigm, a digital assistant is implemented as a master bot that interacts with one or more child bots that are skill bots. For example, in the embodiment depicted in FIG. 1, digital assistant 106 comprises a master bot 114 and skill bots 116-1, 116-2, etc. that are child bots of master bot 114. In some embodiments, digital assistant 106 is itself considered to act as the master bot.

A digital assistant implemented according to the master-child bot architecture enables users of the digital assistant to interact with multiple skills through a unified user interface, namely via the master bot. When a user engages with a digital assistant, the user input is received by the master bot. The master bot then performs processing to determine the meaning of the user input utterance. The master bot then determines whether the task requested by the user in the utterance can be handled by the master bot itself, else the master bot selects an appropriate skill bot for handling the user request and routes the conversation to the selected skill bot. This enables a user to converse with the digital assistant through a common single interface and still provide the capability to use several skill bots configured to perform specific tasks. For example, for a digital assistance developed for an enterprise, the master bot of the digital assistant may interface with skill bots with specific functionalities, such as a CRM bot for performing functions related to customer relationship management (CRM), an ERP bot for performing functions related to enterprise resource planning (ERP), an HCM bot for performing functions related to human capital management (HCM), etc. This way the end user or consumer of the digital assistant need only know how to access the digital assistant through the common master bot interface and behind the scenes multiple skill bots are provided for handling the user request.

In some embodiments, in a master bot/child bots infrastructure, the master bot is configured to be aware of the available list of skill bots. The master bot may have access to metadata that identifies the various available skill bots, and for each skill bot, the capabilities of the skill bot including the tasks that can be performed by the skill bot. Upon receiving a user request in the form of an utterance, the master bot is configured to, from the multiple available skill bots, identify or predict a specific skill bot that can best serve or handle the user request. The master bot then routes the utterance (or a portion of the utterance) to that specific skill bot for further handling. Control thus flows from the master bot to the skill bots. The master bot can support multiple input and output channels. In some embodiments, routing may be performed with the aid of processing performed by one or more available skill bots. For example, as discussed below, a skill bot can be trained to infer an intent for an utterance and to determine whether the inferred intent matches an intent with which the skill bot is configured. Thus, the routing performed by the master bot can involve the skill bot communicating to the master bot an indication of whether the skill bot has been configured with an intent suitable for handling the utterance.

While the embodiment in FIG. 1 shows digital assistant 106 comprising a master bot 114 and skill bots 116-1, 116-2, and 116-3, this is not intended to be limiting. A digital assistant can include various other components (e.g., other systems and subsystems) that provide the functionalities of the digital assistant. These systems and subsystems may be implemented only in software (e.g., code, instructions stored on a computer-readable medium and executable by one or more processors), in hardware only, or in implementations that use a combination of software and hardware.

DABP 102 provides an infrastructure and various services and features that enable a user of DABP 102 to create a digital assistant including one or more skill bots associated with the digital assistant. In some instances, a skill bot can be created by cloning an existing skill bot, for example, cloning a skill bot provided by the skills store. As previously indicated, DABP 102 provides a skills store or skills catalog that offers multiple skill bots for performing various tasks. A user of DABP 102 can clone a skill bot from the skills store. As needed, modifications or customizations may be made to the cloned skill bot. In some other instances, a user of DABP 102 created a skill bot from scratch using tools and services offered by DABP 102. As previously indicated, the skills store or skills catalog provided by DABP 102 may offer multiple skill bots for performing various tasks.

In some embodiments, at a high level, creating or customizing a skill bot involves the following steps:
(1) Configuring settings for a new skill bot
(2) Configuring one or more intents for the skill bot
(3) Configuring one or more entities for one or more intents
(4) Training the skill bot
(5) Creating a dialog flow for the skill bot
(6) Adding custom components to the skill bot as needed
(7) Testing and deploying the skill bot
   Each of the above steps is briefly described below.

(1) Configuring settings for a new skill bot—Various settings may be configured for the skill bot. For example, a skill bot designer can specify one or more invocation names for the skill bot being created. These invocation names can then be used by users of a digital assistant to explicitly invoke the skill bot. For example, a user can input an invocation name in the user's utterance to explicitly invoke the corresponding skill bot.

(2) Configuring one or more intents and associated example utterances for the skill bot—The skill bot designer specifies one or more intents (also referred to as bot intents) for a skill bot being created. The skill bot is then trained based upon these specified intents. These intents represent categories or classes that the skill bot is trained to infer for input utterances. Upon receiving an utterance, a trained skill bot infers an intent for the utterance, where the inferred intent is selected from the predefined set of intents used to train the skill bot. The skill bot then takes an appropriate action responsive to an utterance based upon the intent inferred for that utterance. In some instances, the intents for a skill bot represent tasks that the skill bot can perform for users of the digital assistant. Each intent is given an intent identifier or intent name. For example, for a skill bot trained for a bank, the intents specified for the skill bot may include “CheckBalance,” “TransferMoney,” “DepositCheck,” and the like.

For each intent defined for a skill bot, the skill bot designer may also provide one or more example utterances that are representative of and illustrate the intent. These example utterances are meant to represent utterances that a user may input to the skill bot for that intent. For example, for the CheckBalance intent, example utterances may include “What's my savings account balance?”, “How much is in my checking account?”, “How much money do I have in my account,” and the like. Accordingly, various permutations of typical user utterances may be specified as example utterances for an intent.

The intents and the associated example utterances are used as training data to train the skill bot. Various different training techniques may be used. As a result of this training, a predictive model is generated that is configured to take an utterance as input and output an intent inferred for the utterance by the predictive model. In some instances, input utterances are provided to an intent analysis engine, which is configured to use the trained model to predict or infer an intent for the input utterance. The skill bot may then take one or more actions based upon the inferred intent.

(3) Configuring entities for one or more intents of the skill bot—In some instances, additional context may be needed to enable the skill bot to properly respond to a user utterance. For example, there may be situations where a user input utterance resolves to the same intent in a skill bot. For instance, in the above example, utterances “What's my savings account balance?” and “How much is in my checking account?” both resolve to the same CheckBalance intent, but these utterances are different requests asking for different things. To clarify such requests, one or more entities are added to an intent. Using the banking skill bot example, an entity called AccountType, which defines values called “checking” and “saving” may enable the skill bot to parse the user request and respond appropriately. In the above example, while the utterances resolve to the same intent, the value associated with the AccountType entity is different for the two utterances. This enables the skill bot to perform possibly different actions for the two utterances in spite of them resolving to the same intent. One or more entities can be specified for certain intents configured for the skill bot. Entities are thus used to add context to the intent itself. Entities help describe an intent more fully and enable the skill bot to complete a user request.

In some embodiments, there are two types of entities: (a) built-in entities provided by DABP 102, and (2) custom entities that can be specified by a skill bot designer. Built-in entities are generic entities that can be used with a wide variety of bots. Examples of built-in entities include, without limitation, entities related to time, date, addresses, numbers, email addresses, duration, recurring time periods, currencies, phone numbers, URLs, and the like. Custom entities are used for more customized applications. For example, for a banking skill, an AccountType entity may be defined by the skill bot designer that enables various banking transactions by checking the user input for keywords like checking, savings, and credit cards, etc.

(4) Training the skill bot—A skill bot is configured to receive user input in the form of utterances parse or otherwise process the received input, and identify or select an intent that is relevant to the received user input. As indicated above, the skill bot has to be trained for this. In some embodiments, a skill bot is trained based upon the intents configured for the skill bot and the example utterances associated with the intents (collectively, the training data), so that the skill bot can resolve user input utterances to one of its configured intents. In some embodiments, the skill bot uses a predictive model that is trained using the training data and allows the skill bot to discern what users say (or in some cases, are trying to say). DABP 102 provides various different training techniques that can be used by a skill bot designer to train a skill bot, including various machine learning based training techniques, rules-based training techniques, and/or combinations thereof. In some embodiments, a portion (e.g., 80%) of the training data is used to train a skill bot model and another portion (e.g., the remaining 20%) is used to test or verify the model. Once trained, the trained model (also sometimes referred to as the trained skill bot) can then be used to handle and respond to user utterances. In certain cases, a user's utterance may be a question that requires only a single answer and no further conversation. In order to handle such situations, a Q&A (question-and-answer) intent may be defined for a skill bot. This enables a skill bot to output replies to user requests without having to update the dialog definition. Q&A intents are created in a similar manner as regular intents. The dialog flow for Q&A intents can be different from that for regular intents.

(5) Creating a dialog flow for the skill bot—A dialog flow specified for a skill bot describes how the skill bot reacts as different intents for the skill bot are resolved responsive to received user input. The dialog flow defines operations or actions that a skill bot will take, e.g., how the skill bot responds to user utterances, how the skill bot prompts users for input, how the skill bot returns data. A dialog flow is like a flowchart that is followed by the skill bot. The skill bot designer specifies a dialog flow using a language, such as markdown language. In some embodiments, a version of YAML called OBotML may be used to specify a dialog flow for a skill bot. The dialog flow definition for a skill bot acts as a model for the conversation itself, one that lets the skill bot designer choreograph the interactions between a skill bot and the users that the skill bot services.

In some embodiments, the dialog flow definition for a skill bot contains three sections:
(a) a context section
(b) a default transitions section
(c) a states section

Context section—The skill bot designer can define variables that are used in a conversation flow in the context section. Other variables that may be named in the context section include, without limitation: variables for error handling, variables for built-in or custom entities, user variables that enable the skill bot to recognize and persist user preferences, and the like.

Default transitions section—Transitions for a skill bot can be defined in the dialog flow states section or in the default transitions section. The transitions defined in the default transition section act as a fallback and get triggered when there are no applicable transitions defined within a state, or the conditions required to trigger a state transition cannot be met. The default transitions section can be used to define routing that allows the skill bot to gracefully handle unexpected user actions.

States section—A dialog flow and its related operations are defined as a sequence of transitory states, which manage the logic within the dialog flow. Each state node within a dialog flow definition names a component that provides the functionality needed at that point in the dialog. States are thus built around the components. A state contains component-specific properties and defines the transitions to other states that get triggered after the component executes.

Special case scenarios may be handled using the states sections. For example, there might be times when you want to provide users the option to temporarily leave a first skill they are engaged with to do something in a second skill within the digital assistant. For example, if a user is engaged in a conversation with a shopping skill (e.g., the user has made some selections for purchase), the user may want to jump to a banking skill (e.g., the user may want to ensure that he/she has enough money for the purchase), and then return to the shopping skill to complete the user's order. To address this, an action in the first skill can be configured to initiate an interaction with the second different skill in the same digital assistant and then return to the original flow.

(6) Adding custom components to the skill bot—As described above, states specified in a dialog flow for a skill bot name components that provide the functionality needed corresponding to the states. Components enable a skill bot to perform functions. In some embodiments, DABP 102 provides a set of preconfigured components for performing a wide range of functions. A skill bot designer can select one of more of these preconfigured components and associate them with states in the dialog flow for a skill bot. The skill bot designer can also create custom or new components using tools provided by DABP 102 and associate the custom components with one or more states in the dialog flow for a skill bot.

(7) Testing and deploying the skill bot—DABP 102 provides several features that enable the skill bot designer to test a skill bot being developed. The skill bot can then be deployed and included in a digital assistant.

While the description above describes how to create a skill bot, similar techniques may also be used to create a digital assistant (or the master bot). At the master bot or digital assistant level, built-in system intents may be configured for the digital assistant. These built-in system intents are used to identify general tasks that the digital assistant itself (i.e., the master bot) can handle without invoking a skill bot associated with the digital assistant. Examples of system intents defined for a master bot include: (1) Exit: applies when the user signals the desire to exit the current conversation or context in the digital assistant; (2) Help: applies when the user asks for help or orientation; and (3) UnresolvedIntent: applies to user input that doesn't match well with the exit and help intents. The digital assistant also stores information about the one or more skill bots associated with the digital assistant. This information enables the master bot to select a particular skill bot for handling an utterance.

At the master bot or digital assistant level, when a user inputs a phrase or utterance to the digital assistant, the digital assistant is configured to perform processing to determine how to route the utterance and the related conversation. The digital assistant determines this using a routing model, which can be rules-based, AI-based, or a combination thereof. The digital assistant uses the routing model to determine whether the conversation corresponding to the user input utterance is to be routed to a particular skill for handling, is to be handled by the digital assistant or master bot itself per a built-in system intent, or is to be handled as a different state in a current conversation flow.

In some embodiments, as part of this processing, the digital assistant determines if the user input utterance explicitly identifies a skill bot using its invocation name. If an invocation name is present in the user input, then it is treated as explicit invocation of the skill bot corresponding to the invocation name. In such a scenario, the digital assistant may route the user input to the explicitly invoked skill bot for further handling. If there is no specific or explicit invocation, in some embodiments, the digital assistant evaluates the received user input utterance and computes confidence scores for the system intents and the skill bots associated with the digital assistant. The score computed for a skill bot or system intent represents how likely the user input is representative of a task that the skill bot is configured to perform or is representative of a system intent. Any system intent or skill bot with an associated computed confidence score exceeding a threshold value (e.g., a Confidence Threshold routing parameter) is selected as a candidate for further evaluation. The digital assistant then selects, from the identified candidates, a particular system intent or a skill bot for further handling of the user input utterance. In some embodiments, after one or more skill bots are identified as candidates, the intents associated with those candidate skills are evaluated (according to the intent model for each skill) and confidence scores are determined for each intent. In general, any intent that has a confidence score exceeding a threshold value (e.g., 70%) is treated as a candidate intent. If a particular skill bot is selected, then the user utterance is routed to that skill bot for further processing. If a system intent is selected, then one or more actions are performed by the master bot itself according to the selected system intent.

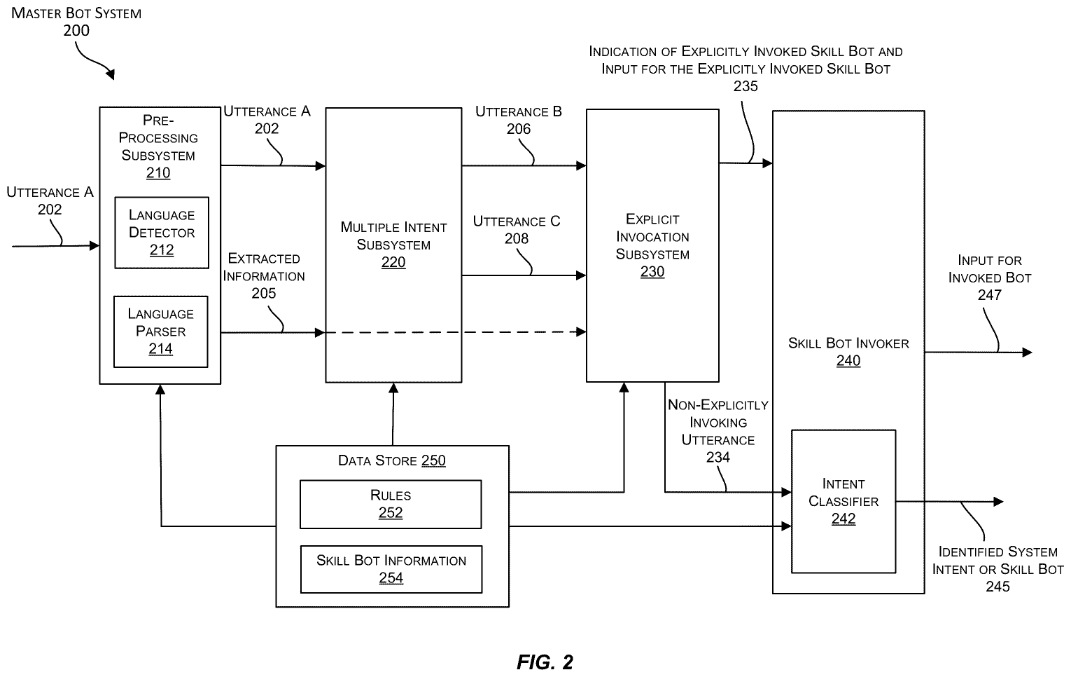

FIG. 2 is a simplified block diagram of a master bot (MB) system 200 according to some embodiments. MB system 200 can be implemented in software only, hardware only, or a combination of hardware and software. MB system 200 includes a pre-processing subsystem 210, a multiple intent subsystem (MIS) 220, an explicit invocation subsystem (EIS) 230, a skill bot invoker 240, and a data store 250. MB system 200 depicted in FIG. 2 is merely an example of an arrangement of components in a master bot. One of ordinary skill in the art would recognize many possible variations, alternatives, and modifications. For example, in some implementations, MB system 200 may have more or fewer systems or components than those shown in FIG. 2, may combine two or more subsystems, or may have a different configuration or arrangement of subsystems.

Pre-processing subsystem 210 receives an utterance “A” 202 from a user and processes the utterance through a language detector 212 and a language parser 214. As indicated above, an utterance can be provided in various ways including audio or text. The utterance 202 can be a sentence fragment, a complete sentence, multiple sentences, and the like. Utterance 202 can include punctuation. For example, if the utterance 202 is provided as audio, the pre-processing subsystem 210 may convert the audio to text using a speech-to-text converter (not shown) that inserts punctuation marks into the resulting text, e.g., commas, semicolons, periods, etc.

Language detector 212 detects the language of the utterance 202 based on the text of the utterance 202. The manner in which the utterance 202 is handled depends on the language since each language has its own grammar and semantics. Differences between languages are taken into consideration when analyzing the syntax and structure of an utterance.

Language parser 214 parses the utterance 202 to extract part of speech (POS) tags for individual linguistic units (e.g., words) in the utterance 202. POS tags include, for example, noun (NN), pronoun (PN), verb (VB), and the like. Language parser 214 may also tokenize the linguistic units of the utterance 202 (e.g., to convert each word into a separate token) and lemmatize words. A lemma is the main form of a set of words as represented in a dictionary (e.g., “run” is the lemma for run, runs, ran, running, etc.). Other types of pre-processing that the language parser 214 can perform include chunking of compound expressions, e.g., combining “credit” and “card” into a single expression “credit_card.” Language parser 214 may also identify relationships between the words in the utterance 202. For example, in some embodiments, the language parser 214 generates a dependency tree that indicates which part of the utterance (e.g. a particular noun) is a direct object, which part of the utterance is a preposition, and so on. The results of the processing performed by the language parser 214 form extracted information 205 and are provided as input to MIS 220 together with the utterance 202 itself.

As indicated above, the utterance 202 can include more than one sentence. For purposes of detecting multiple intents and explicit invocation, the utterance 202 can be treated as a single unit even if it includes multiple sentences. However, in some embodiments, pre-processing can be performed, e.g., by the pre-processing subsystem 210, to identify a single sentence among multiple sentences for multiple intents analysis and explicit invocation analysis. In general, the results produced by MIS 220 and EIS 230 are substantially the same regardless of whether the utterance 202 is processed at the level of an individual sentence or as a single unit comprising multiple sentences.

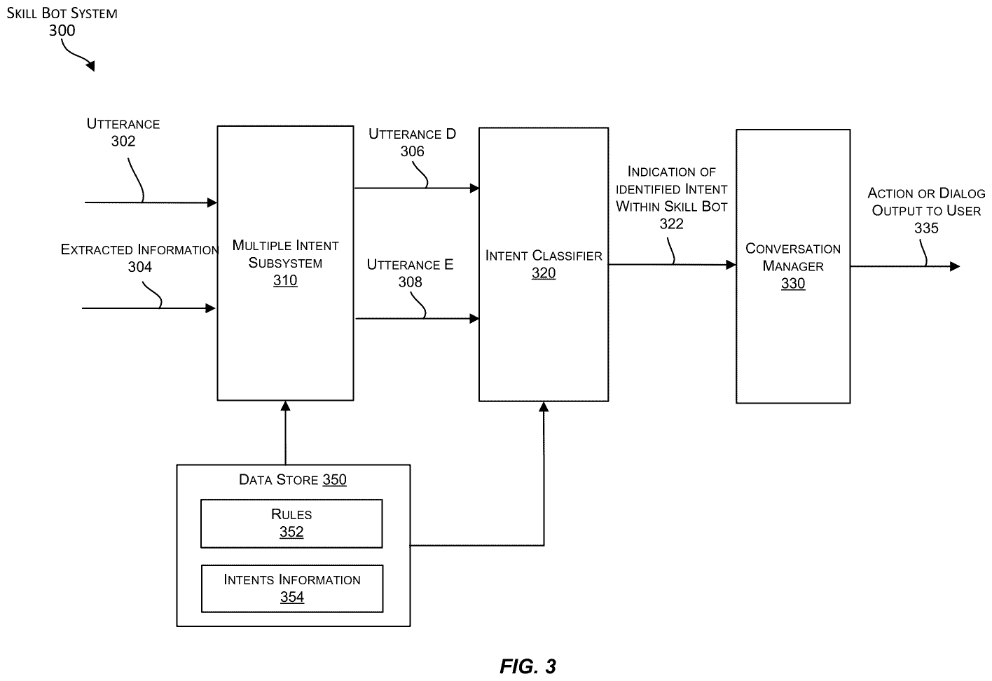

MIS 220 determines whether the utterance 202 represents multiple intents. Although MIS 220 can detect the presence of multiple intents in the utterance 202, the processing performed by MIS 220 does not involve determining whether the intents of the utterance 202 match to any intents that have been configured for a bot. Instead, processing to determine whether an intent of the utterance 202 matches a bot intent can be performed by an intent classifier 242 of the MB system 200 or by an intent classifier of a skill bot (e.g., as shown in the embodiment of FIG. 3). The processing performed by MIS 220 assumes that there exists a bot (e.g., a particular skill bot or the master bot itself) that can handle the utterance 202. Therefore, the processing performed by MIS 220 does not require knowledge of what bots are in the chatbot system (e.g., the identities of skill bots registered with the master bot) or knowledge of what intents have been configured for a particular bot.

To determine that the utterance 202 includes multiple intents, the MIS 220 applies one or more rules from a set of rules 252 in the data store 250. The rules applied to the utterance 202 depend on the language of the utterance 202 and may include sentence patterns that indicate the presence of multiple intents. For example, a sentence pattern may include a coordinating conjunction that joins two parts (e.g., conjuncts) of a sentence, where both parts correspond to a separate intent. If the utterance 202 matches the sentence pattern, it can be inferred that the utterance 202 represents multiple intents. It should be noted that an utterance with multiple intents does not necessarily have different intents (e.g., intents directed to different bots or to different intents within the same bot). Instead, the utterance could have separate instances of the same intent, e.g. “Place a pizza order using payment account X, then place a pizza order using payment account Y.”

As part of determining that the utterance 202 represents multiple intents, the MIS 220 also determines what portions of the utterance 202 are associated with each intent. MIS 220 constructs, for each intent represented in an utterance containing multiple intents, a new utterance for separate processing in place of the original utterance, e.g., an utterance “B” 206 and an utterance “C” 208, with respect to FIG. 2. Thus, the original utterance 202 can be split into two or more separate utterances that are handled one at a time. MIS 220 determines, using the extracted information 205 and/or from analysis of the utterance 202 itself, which of the two or more utterances should be handled first. For example, MIS 220 may determine that the utterance 202 contains a marker word indicating that a particular intent should be handled first. The newly formed utterance corresponding to this particular intent (e.g., one of utterance 206 or utterance 208) will be the first to be sent for further processing by EIS 230. After a conversation triggered by the first utterance has ended (or has been temporarily suspended), the next highest priority utterance (e.g., the other one of utterance 206 or utterance 208) can then be sent to the EIS 230 for processing.

EIS 230 determines whether the utterance that it receives (e.g., utterance 206 or utterance 208) contains an invocation name of a skill bot. In some embodiments, each skill bot in a chatbot system is assigned a unique invocation name that distinguishes the skill bot from other skill bots in the chatbot system. A list of invocation names can be maintained as part of skill bot information 254 in data store 250. An utterance is deemed to be an explicit invocation when the utterance contains a word match to an invocation name. If a bot is not explicitly invoked, then the utterance received by the EIS 230 is deemed a non-explicitly invoking utterance 234 and is input to an intent classifier (e.g., intent classifier 242) of the master bot to determine which bot to use for handling the utterance. In some instances, the intent classifier 242 will determine that the master bot should handle a non-explicitly invoking utterance. In other instances, the intent classifier 242 will determine a skill bot to route the utterance to for handling.

The explicit invocation functionality provided by the EIS 230 has several advantages. It can reduce the amount of processing that the master bot has to perform. For example, when there is an explicit invocation, the master bot may not have to do any intent classification analysis (e.g., using the intent classifier 242), or may have to do reduced intent classification analysis for selecting a skill bot. Thus, explicit invocation analysis may enable selection of a particular skill bot without resorting to intent classification analysis.

Also, there may be situations where there is an overlap in functionalities between multiple skill bots. This may happen, for example, if the intents handled by the two skill bots overlap or are very close to each other. In such a situation, it may be difficult for the master bot to identify which of the multiple skill bots to select based upon intent classification analysis alone. In such scenarios, the explicit invocation disambiguates the particular skill bot to be used.

In addition to determining that an utterance is an explicit invocation, the EIS 230 is responsible for determining whether any portion of the utterance should be used as input to the skill bot being explicitly invoked. In particular, EIS 230 can determine whether part of the utterance is not associated with the invocation. The EIS 230 can perform this determination through analysis of the utterance and/or analysis of the extracted information 205. EIS 230 can send the part of the utterance not associated with the invocation to the invoked skill bot in lieu of sending the entire utterance that was received by the EIS 230. In some instances, the input to the invoked skill bot is formed simply by removing any portion of the utterance associated with the invocation. For example, “I want to order pizza using Pizza Bot” can be shortened to “I want to order pizza” since “using Pizza Bot” is relevant to the invocation of the pizza bot, but irrelevant to any processing to be performed by the pizza bot. In some instances, EIS 230 may reformat the part to be sent to the invoked bot, e.g., to form a complete sentence. Thus, the EIS 230 determines not only that there is an explicit invocation, but also what to send to the skill bot when there is an explicit invocation. In some instances, there may not be any text to input to the bot being invoked. For example, if the utterance was “Pizza Bot”, then the EIS 230 could determine that the pizza bot is being invoked, but there is no text to be processed by the pizza bot. In such scenarios, the EIS 230 may indicate to the skill bot invoker 240 that there is nothing to send.

Skill bot invoker 240 invokes a skill bot in various ways. For instance, skill bot invoker 240 can invoke a bot in response to receiving an indication 235 that a particular skill bot has been selected as a result of an explicit invocation. The indication 235 can be sent by the EIS 230 together with the input for the explicitly invoked skill bot. In this scenario, the skill bot invoker 240 will turn control of the conversation over to the explicitly invoked skill bot. The explicitly invoked skill bot will determine an appropriate response to the input from the EIS 230 by treating the input as a stand-alone utterance. For example, the response could be to perform a specific action or to start a new conversation in a particular state, where the initial state of the new conversation depends on the input sent from the EIS 230.

Another way in which skill bot invoker 240 can invoke a skill bot is through implicit invocation using the intent classifier 242. The intent classifier 242 can be trained, using machine learning and/or rules-based training techniques, to determine a likelihood that an utterance is representative of a task that a particular skill bot is configured to perform. The intent classifier 242 is trained on different classes, one class for each skill bot. For instance, whenever a new skill bot is registered with the master bot, a list of example utterances associated with the new skill bot can be used to train the intent classifier 242 to determine a likelihood that a particular utterance is representative of a task that the new skill bot can perform. The parameters produced as result of this training (e.g., a set of values for parameters of a machine learning model) can be stored as part of skill bot information 254.

In some embodiments, the intent classifier 242 is implemented using a machine learning model, as described in further detail herein. Training of the machine learning model may involve inputting at least a subset of utterances from the example utterances associated with various skill bots to generate, as an output of the machine learning model, inferences as to which bot is the correct bot for handling any particular training utterance. For each training utterance, an indication of the correct bot to use for the training utterance may be provided as ground truth information. The behavior of the machine learning model can then be adapted (e.g., through back-propagation) to minimize the difference between the generated inferences and the ground truth information.

In some embodiments, the intent classifier 242 determines, for each skill bot registered with the master bot, a confidence score indicating a likelihood that the skill bot can handle an utterance (e.g., the non-explicitly invoking utterance 234 received from EIS 230). The intent classifier 242 may also determine a confidence score for each system level intent (e.g., help, exit) that has been configured. If a particular confidence score meets one or more conditions, then the skill bot invoker 240 will invoke the bot associated with the particular confidence score. For example, a threshold confidence score value may need to be met. Thus, an output 245 of the intent classifier 242 is either an identification of a system intent or an identification of a particular skill bot. In some embodiments, in addition to meeting a threshold confidence score value, the confidence score must exceed the next highest confidence score by a certain win margin. Imposing such a condition would enable routing to a particular skill bot when the confidence scores of multiple skill bots each exceed the threshold confidence score value.

After identifying a bot based on evaluation of confidence scores, the skill bot invoker 240 hands over processing to the identified bot. In the case of a system intent, the identified bot is the master bot. Otherwise, the identified bot is a skill bot. Further, the skill bot invoker 240 will determine what to provide as input 247 for the identified bot. As indicated above, in the case of an explicit invocation, the input 247 can be based on a part of an utterance that is not associated with the invocation, or the input 247 can be nothing (e.g., an empty string). In the case of an implicit invocation, the input 247 can be the entire utterance.

Data store 250 comprises one or more computing devices that store data used by the various subsystems of the master bot system 200. As explained above, the data store 250 includes rules 252 and skill bot information 254. The rules 252 include, for example, rules for determining, by MIS 220, when an utterance represents multiple intents and how to split an utterance that represents multiple intents. The rules 252 further include rules for determining, by EIS 230, which parts of an utterance that explicitly invokes a skill bot to send to the skill bot. The skill bot information 254 includes invocation names of skill bots in the chatbot system, e.g., a list of the invocation names of all skill bots registered with a particular master bot. The skill bot information 254 can also include information used by intent classifier 242 to determine a confidence score for each skill bot in the chatbot system, e.g., parameters of a machine learning model.

FIG. 3 is a simplified block diagram of a skill bot system 300 according to some embodiments. Skill bot system 300 is a computing system that can be implemented in software only, hardware only, or a combination of hardware and software. In some embodiments such as the embodiment depicted in FIG. 1, skill bot system 300 can be used to implement one or more skill bots within a digital assistant.

Skill bot system 300 includes an MIS 310, an intent classifier 320, and a conversation manager 330. The MIS 310 is analogous to the MIS 220 in FIG. 2 and provides similar functionality, including being operable to determine, using rules 352 in a data store 350: (1) whether an utterance represents multiple intents and, if so, (2) how to split the utterance into a separate utterance for each intent of the multiple intents. In some embodiments, the rules applied by MIS 310 for detecting multiple intents and for splitting an utterance are the same as those applied by MIS 220. The MIS 310 receives an utterance 302 and extracted information 304. The extracted information 304 is analogous to the extracted information 205 in FIG. 1 and can be generated using the language parser 214 or a language parser local to the skill bot system 300.

Intent classifier 320 can be trained in a similar manner to the intent classifier 242 discussed above in connection with the embodiment of FIG. 2 and as described in further detail herein. For instance, in some embodiments, the intent classifier 320 is implemented using a machine learning model. The machine learning model of the intent classifier 320 is trained for a particular skill bot, using at least a subset of example utterances associated with that particular skill bot as training utterances. The ground truth for each training utterance would be the particular bot intent associated with the training utterance.

The utterance 302 can be received directly from the user or supplied through a master bot. When the utterance 302 is supplied through a master bot, e.g., as a result of processing through MIS 220 and EIS 230 in the embodiment depicted in FIG. 2, the MIS 310 can be bypassed so as to avoid repeating processing already performed by MIS 220. However, if the utterance 302 is received directly from the user, e.g., during a conversation that occurs after routing to a skill bot, then MIS 310 can process the utterance 302 to determine whether the utterance 302 represents multiple intents. If so, then MIS 310 applies one or more rules to split the utterance 302 into a separate utterance for each intent, e.g., an utterance “D” 306 and an utterance “E” 308. If utterance 302 does not represent multiple intents, then MIS 310 forwards the utterance 302 to intent classifier 320 for intent classification and without splitting the utterance 302.

Intent classifier 320 is configured to match a received utterance (e.g., utterance 306 or 308) to an intent associated with skill bot system 300. As explained above, a skill bot can be configured with one or more intents, each intent including at least one example utterance that is associated with the intent and used for training a classifier. In the embodiment of FIG. 2, the intent classifier 242 of the master bot system 200 is trained to determine confidence scores for individual skill bots and confidence scores for system intents. Similarly, intent classifier 320 can be trained to determine a confidence score for each intent associated with the skill bot system 300. Whereas the classification performed by intent classifier 242 is at the bot level, the classification performed by intent classifier 320 is at the intent level and therefore finer grained. The intent classifier 320 has access to intents information 354. The intents information 354 includes, for each intent associated with the skill bot system 300, a list of utterances that are representative of and illustrate the meaning of the intent and are typically associated with a task performable by that intent. The intents information 354 can further include parameters produced as a result of training on this list of utterances.

Conversation manager 330 receives, as an output of intent classifier 320, an indication 322 of a particular intent, identified by the intent classifier 320, as best matching the utterance that was input to the intent classifier 320. In some instances, the intent classifier 320 is unable to determine any match. For example, the confidence scores computed by the intent classifier 320 could fall below a threshold confidence score value if the utterance is directed to a system intent or an intent of a different skill bot. When this occurs, the skill bot system 300 may refer the utterance to the master bot for handling, e.g., to route to a different skill bot. However, if the intent classifier 320 is successful in identifying an intent within the skill bot, then the conversation manager 330 will initiate a conversation with the user.

The conversation initiated by the conversation manager 330 is a conversation specific to the intent identified by the intent classifier 320. For instance, the conversation manager 330 may be implemented using a state machine configured to execute a dialog flow for the identified intent. The state machine can include a default starting state (e.g., for when the intent is invoked without any additional input) and one or more additional states, where each state has associated with it actions to be performed by the skill bot (e.g., executing a purchase transaction) and/or dialog (e.g., questions, responses) to be presented to the user. Thus, the conversation manager 330 can determine an action/dialog 335 upon receiving the indication 322 identifying the intent, and can determine additional actions or dialog in response to subsequent utterances received during the conversation.

Data store 350 comprises one or more computing devices that store data used by the various subsystems of the skill bot system 300. With respect to FIG. 3, the data store 350 includes the rules 352 and the intents information 354. In some embodiments, data store 350 can be integrated into a data store of a master bot or digital assistant, e.g., the data store 250 in FIG. 2.

### Digital Assistant Using Large Language Model Block Handling

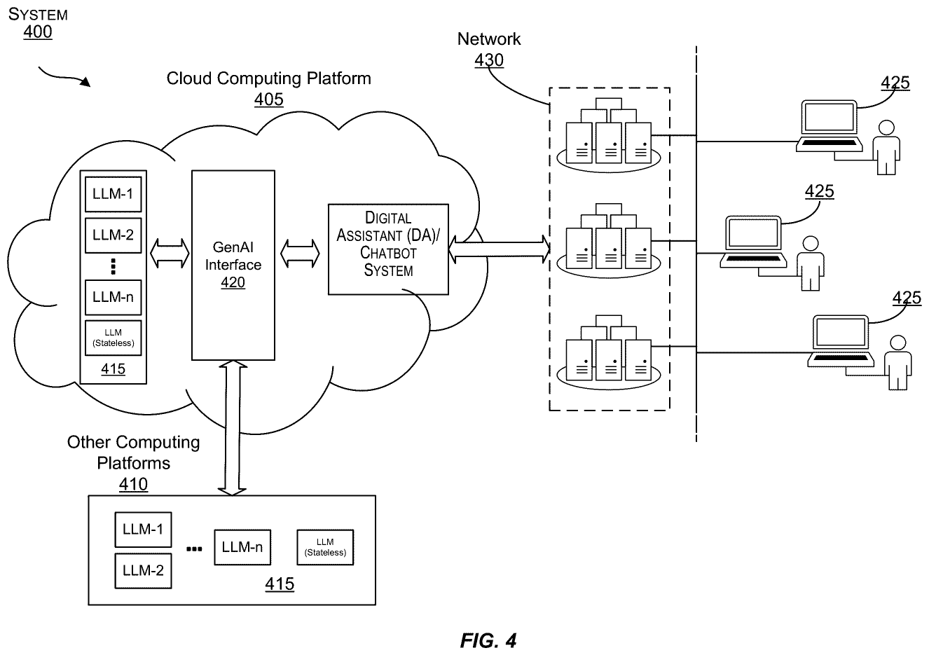

FIG. 4 illustrates an example system 400 for enabling the integration of large language models (LLMs) with digital assistants (e.g., DAs described with respect to FIGS. 1-3) to enhance skills with generative AI capabilities. These capabilities include handling small talk with a user, generating written summaries of data, automating challenging or repetitive business tasks, such as those required for talent acquisition, and providing sentiment analysis of a given piece of text to determine whether it reflects a positive, negative, or neutral opinion. Using the Invoke Large Language Model component, a skill bot developer can plug these capabilities into their dialog flow wherever they're needed. This dialog flow component is the primary integration piece for generative AI in that it contacts the LLM that are hosted on one or more computing platforms such as cloud platforms, on-premises platforms, edge platforms, etc. through a call (e.g., a REST call), then sends the LLM a prompt (the natural language instructions to the LLM) along with related parameters. It then returns the results generated by the model (which are also known as completions) and manages the state of the LLM-user interactions so that its responses remain in context after successive rounds of user queries and feedback. The LLM component can call any LLM. A user can add one or more LLM component states (or LLM blocks) to flows. A user can also chain the LLM calls so that the output of one LLM request can be passed to a subsequent LLM request.

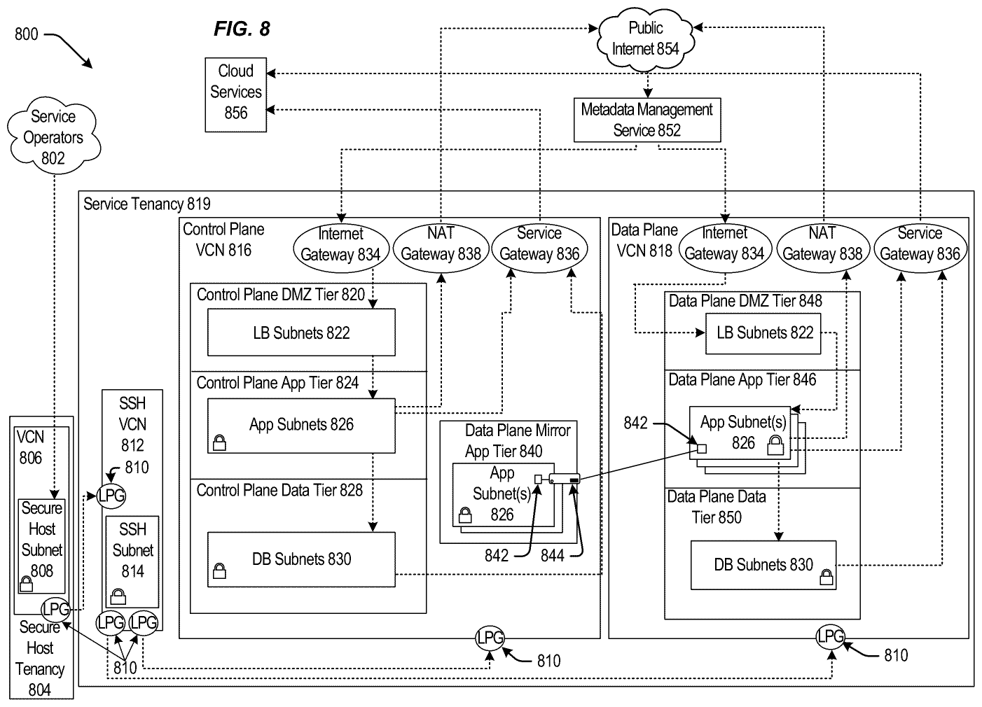

The system 400 includes a cloud computing platform 405 (e.g., an IaaS platform such as Oracle Cloud Infrastructure as described in detail with respect to FIGS. 8-12) and other computing platforms 410 configured to provide services including the capability to interact with digital assistants enhanced with the LLM component for invoking LLMs 415 hosted by one or more LLM service providers. In some embodiments, the cloud computing platform 405 hosts the LLMs 415 for the one or more LLM service providers. In other embodiments, the one or more other computing platform(s) 410 such as one or more other cloud platforms, one or more on-premises platforms, one or more edge platforms, etc. hosts the LLMs 415 for the one or more LLM service providers. In other embodiments, the cloud computing platform 405 hosts some of the LLMs 415 for some of the one or more LLM service providers and the one or more other computing platform(s) 410 hosts some of the LLMs 415 for some of the one or more LLM service providers. The LLMs 415 include a collection of multiple LLMs (e.g., GPT-4, LaMDA, etc.) that can be used for processing various generative artificial intelligence tasks (e.g., natural language understanding and processing) to provide efficient, user centric and context aware responses to one or more users.

Besides the LLM component, the other major pieces of the LLM integration include endpoints for the one or more LLM service provider and transformation handlers for converting the request and response payloads to and from the digital assistant's format using the Common LLM Interface (CLMI) (also described herein as the GenAI Interface 420). Follows are the high-level steps for adding these and other components to create the LLM integration for a skill:
Register an API service in the digital assistant instance for the LLM's endpoint (e.g., REST endpoint).
For the skill, create a LLM Transformation Event Handler to convert the LLM request and response payloads to and from CLMI using the GenAI Interface 420.
   In some instances, prebuilt handlers are provided for example if a user is integrating their skill with the Cohere model or with Oracle Generative AI Service. If they are accessing other models, such as Azure OpenAI, the user can update the starter transformation code that is provided using a declarative process.
Define an LLM service for the skill that maps to the service that the user has registered to the instance with an LLM Transformation Handler.
In the flow of the skill where the user wants to use the LLM, insert and configure an LLM component by adding the prompt text and setting other parameters.
   The prompt text and/or template can be added using a Prompt Builder (accessed through the LLM component) to perfect and test the prompt.

Once the LLM integration is configured, the CLMI or GenAI interface 420 enables the LLM component to handle these request and response payloads (e.g., translate, moderate, and validate responses and requests). In general, the GenAI interface 420 is comprised of various components for handling the following:
A request body specification
A success response body specification, applicable when LLM call returns an standard response such as a HTTP 200 status
An error response body specification, applicable when the LLM call returns a status other than an standard response, and the LLM invocation itself was successful. For example, in case of HTTP status code 401 (not authorized) or 500 (internal server error) the LLM is not successfully invoked hence no response body is expected. The VFD LLM component will handle these status codes separately.
A moderation request body
A moderation response body

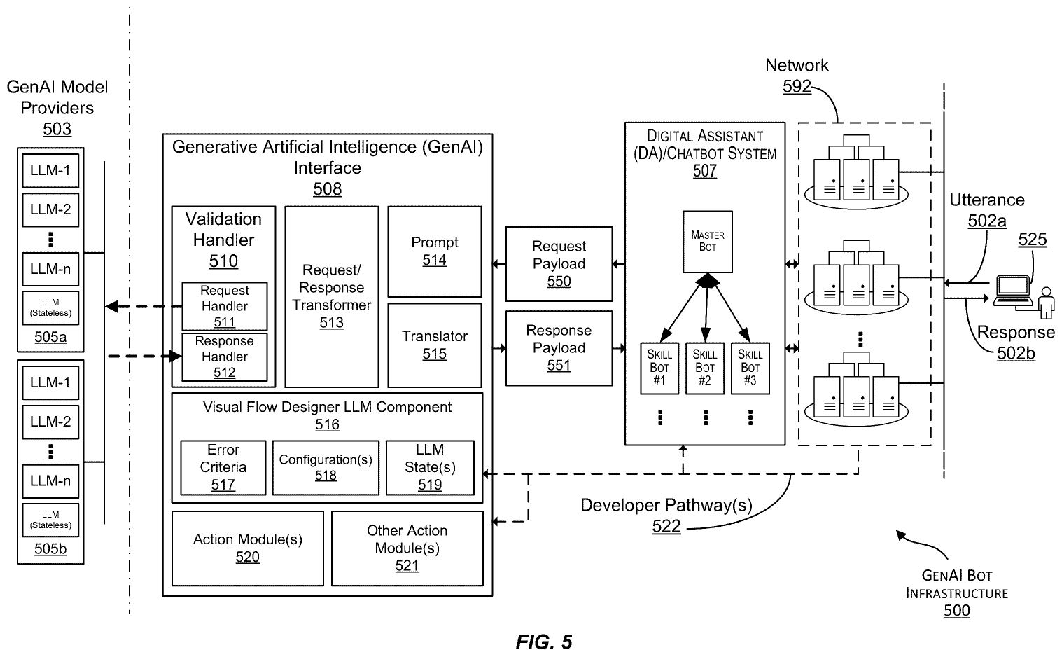

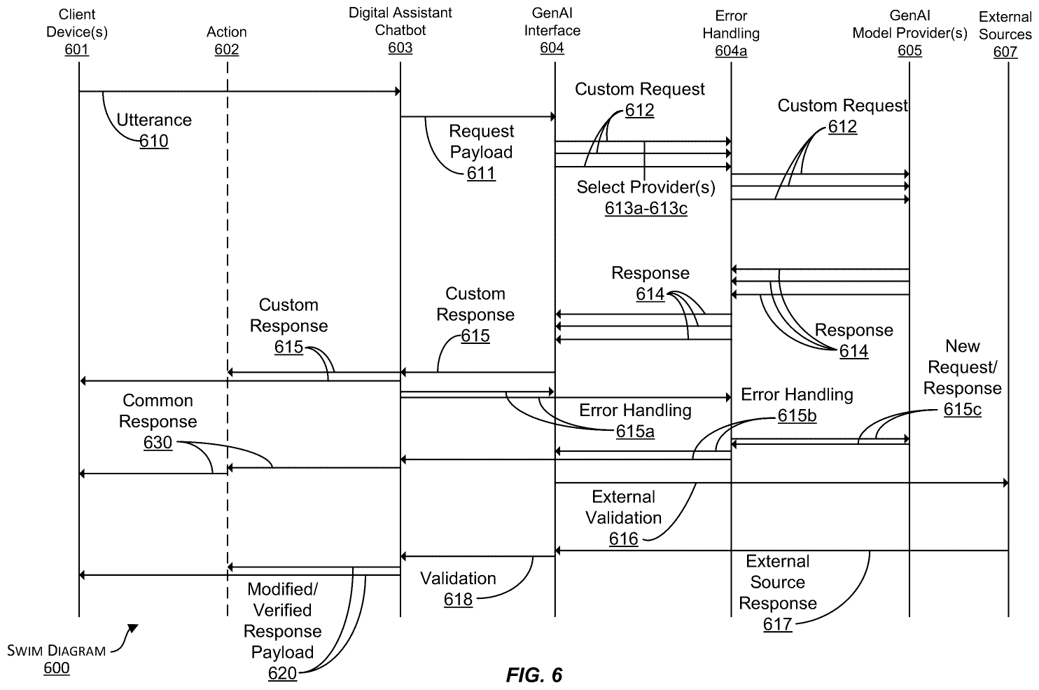

The system 400 further includes one or more client devices 425 (e.g., personal computing device, mobile device, kiosk, IoT device, etc.) that can be used by one or more users to interact with the services provided by the cloud computing platform 405 and other computing platforms 410 (optionally via the one or more netwroks 430, which may host applications or websites that are used to interact with the services). As discussed below in greater detail with respect to FIGS. 5 and 6, users using the client devices 425 may send utterances (e.g., queries) or commands to the digital assistant/chatbot system for processing including LLM integration via the LLM component and the CLMI or GenAI interface 420.

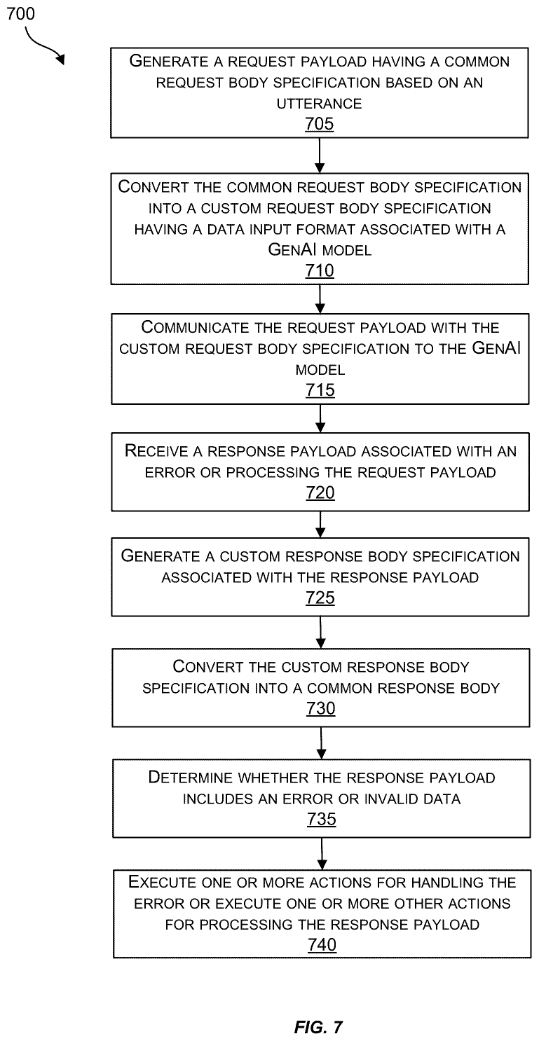

FIG. 5 illustrates an example simplified GenAI Bot Infrastructure 500 that implements LLM integration (e.g., via GenAI interface 420 described with respect to FIG. 4) for transforming, processing, and validating response and request payloads, according to various embodiments. The GenAI Bot Infrastructure 500 may include one or more components from devices of FIGS. 1-4 or 8-12, and/or operate according to methods, processes or techniques as in FIG. 6 or 7. By way of example, the GenAI Bot Infrastructure 500 includes a GenAI Interface 508 for error and/or validation handling of payloads related from client device(s) 525 (e.g., smartphone, web interface, etc.) operated by users (e.g., users of DA 108 with respect to FIG. 1). The users, without limitation, may be customers of enterprises, developers of software, or any user capable of providing an utterance 502a (e.g., utterance A 202 with respect to FIG. 2). For example, a user may access a website which includes chatbot support (e.g., DA/chatbot system 106 with respect to FIG. 1) and request assistance ordering a new ladder, but is unsure which sizes are available. The chatbot may receive a question from the user such as, “I am looking for a collapsible twelve-foot ladder”. The chatbot may then invoke subsystems to determine an intent (e.g., multiple intent subsystem 220 with respect to FIG. 2), various rules (e.g., rules 252 with respect to FIG. 2), and respond with an answer or information to the user (e.g., dialog output 335 to user with respect to FIG. 3) such as providing a link to collapsible twelve-foot ladders, offering to add a twelve-foot ladder to the user's shopping cart, or similar resolutions.

As discussed previously, the users may use the client device(s) 525 to provide the utterance 502a over a network 592 (e.g., Internet). That utterance 502a may then be relayed from an interface (e.g., web-based storefront) to a Digital Assistant (DA) Chatbot System 507 (e.g., DA/Chatbot System 106 with respect to FIG. 1) for handling by a chatbot (e.g., master bot, skill bot #1-#3, etc.) as discussed in more detail further on.

Some conventional chatbot systems may be limited by pre-existing and/or preset responses and/or guidelines which may limit the utterances that the chatbot can process and/or the responses the chatbot system can provide. For example, users may provide requests that require knowledge or actions outside of the capabilities of the chatbot (e.g., complex utterances). For example, a skill bot may receive an utterance from a user, “I'm forty-three and I would like to know what my options are for 401k investment strategies for a target retirement by sixty years old.”. In these instances, the DA/Chatbot System 507 selects one or more appropriate skill bots (e.g., skill bot #1, skill bot #2, etc.) to attempt to provide a response. One or more of the skill bots may be unable to provide a full and adequate response to the user due to the complexity of the utterance 502a. While the skill bot may be able to provide 401k investment strategies, or target strategies for retiring by sixty years old, the skill bot may be unable to combine the two ideas into one coherent deterministic response. In these examples, the DA/Chatbot System 507 uses LLM integration, which includes invoking a LLM component, creating a request payload 550 that includes the utterance 502a, and communicating the request payload 550 to the GenAI Interface 508 for further processing.

In response to use of LLM intergation, the DA/Chatbot System 507 generates a request payload 550 having a common request body specification which includes the utterance 502a. The request payload 550 may be a transformed payload of the utterance 502a and may be represented based on JSON syntax and contain, but not limited to, one or more of the following properties:
i) messages
ii) streamResponse
iii) maxTokens
iv) temperature
v) user
vi) providerExtension.

i) messages: The request may include a list of messages. The message may be a prompt with a role property (e.g., the user that created the message). In some examples, the role property may be from a system (e.g., chatbot, client deice 525, or similar). The message may include the utterance 502a (e.g., the original natural language message from the user), a “turn” (e.g., a number indicating a current refinement turn of the chat messages exchange with a first prompt representing turn “1”), a retry (e.g., flag that may indicate where the message set sent to fix an GenAI Model 505 error), or a tag (e.g., a custom tag to mark a specific prompt). For example, the tag may be set to “criticize” or “improve” so that custom logic in a validation handler (e.g., validation handler 510) may detect a “position” in the process. If the GenAI Model 505 (discussed in more detail further on) supports a multi-turn conversation to enhance the GenAI Model 505 response, subsequent messages may be pairs of user and assistant role messages (e.g., the user message contains the follow-up instruction/question for the GenAI Model 505, the assistant message contains the GenAI Model 505 response to the user message). If the GenAI Model 505 does not support multi-turn conversations, then the messages array may contain a single system message holding the prompt.

ii) streamResponse: If set to true, the GenAI Model 505 response may be streamed back to the user. A Visual Flow Designer (VFD) LLM Component 516 (discussed in more detail further on) may then send a partial response messages back to the user which may lead to an enhanced experience because the user may not have to wait until the GenAI Model 505 completed the response. In this manner, the user will get intermediate results back more quickly.

iii) maxTokens: The maximum number of tokens the GenAI Model 505 may use to generate the response. Tokens can be thought of as pieces of words, one hundred tokens roughly equal seventy-five words in English.

iv) temperature: Temperature may be used by the GenAI Model 505 to govern a randomness and thus a creativity of the responses. The temperature may be a number between zero and one. A temperature of zero may mean the responses may be straightforward and substantially deterministic (e.g., producing substantially similar responses to a given prompt). A temperature of one may mean the responses can vary probabilistically (e.g., producing substantially different responses to a given prompt). For GenAI Provider(s) 503 that may support a wider range than zero to one. In these examples, the validation handler 510 may be used to apply a multiplier.

v) user: A unique identifier that may represent an end-user which may help monitoring and detecting errors, content, moderation, or abuse of the system.

vi) providerExtension: The property may allow for GenAI Model Providers 503 specific configuration options that are may not be defined as part of GenAI Interface 508. In some examples, a chatbot developer may add provider specific configurations for the validation handler 510.

While the context of the request payloads 550 are discussed in reference to JSON, it should not be considered limiting and one skilled in the art would recognize that any suitable syntax language may be used for communication with various components of the infrastructure 500.

According to some embodiments, the validation handler 510 of GenAI Interface 508 implements a translator 515 to process incoming request payloads 550. This translator 515 serves as the intermediary between incoming request payloads 550 (e.g., JSON payloads) from client device(s) 525 and the request/response transformer 513. One non-limiting approach for handling this scenario would be for a first request payload 550 to trigger a translation of the utterance 502a from a JSON format to a free text (or other query) to be fed to the GenAI Providers 503. However, this approach may use a number of back-and-forth transformations for every request payload 550 and response payload 551 (discussed in more detail further on). Thus, some embodiments instead integrate the translator 515 to automatically convert commands to free text.

In some examples, a translate function itself may not be used by the translator 515 though the initialization may be implemented to call commands for requesting a prompt (e.g., from prompt module 514) and validation may be done by the validation handler 510. In addition, or alternatively, in lieu of directly using a “translate” function, the translator 515 may process these commands to extract the prompts and any additional information required for interaction. For example, a “createRequestPrompt” function may be implemented that can take the prompts from the commands and transform them in a format suitable. This may involve structuring the prompts 514 as a request to be later relayed to the GenAI Providers 503.

According to some embodiments, the translator 515 invokes guardrails and content moderation. The guardrails may be implemented so as to dynamically, and in real-time, process utterances 502a for which a request payload 550 has been requested to be processed and relayed to the GenAI Providers 503. The guardrails may perform checks for potential malicious input and/or indirect attacks. Here, the validation handler 510 of the GenAI Interface 508 may be used to perform validation of data input to the GenAI Model Providers 503 or output from the GenAI Models 505. Using the validation handler 510 may facilitate easier integration with interfaces, information and understandings associated with client device(s) 525. For example, the validation handler 510 may reject any output with a format that may not be consistent with the example data fed to the GenAI Model 505 via a prompt.

The GenAI Interface 508 provides multiple forms of guardrails to enhance the security of prompts communication. Preventive guardrails implement access control policies on the users prompts that they provide the prompts to the GenAI Model Providers 503 by implementing compliance standards that disallow a set of actions that might violate pre-existing policies. The guardrails enable valid data provision to chatbots and GenAI Models 505 preventing attacks such as SQL injection and cross-site scripting (XSS) by rejecting or sanitizing malicious input. In some examples, rate-limiting guardrails are implemented to prevent brute force and denial-of-service attacks by restricting the number of requests that are made to conversational applications and GenAI Models 505 within a specified time frame. By implementing these technical guardrails, strong security measures are provided for the chatbots and GenAI Models 505.

The guardrails may minimize the risk of malicious input and attacks, which may disrupt enterprise flows. By ensuring that only valid and safe inputs are processed by GenAI Models 505 and chatbots, businesses can maintain the determinism of their processes. Guardrails, such as data encryption and access controls, may protect sensitive business data from unauthorized access or data breaches. This ensures that the integrity and confidentiality of data are maintained within the deterministic business flow. With security measures in place, the business may confidently integrate GenAI Models 505 without worrying about potential security risks that could disrupt operations. This allows the business to maintain its deterministic flow even in the presence of advanced AI components.

In some examples, when the prompts are received by the validation handler 510 from the prompt module 514, it may also involve structure validation and client-specific content moderation by providing a content moderator. Some types of content are required to be moderated via laws or regulations of applicable jurisdictions. When a request payload 550 is received at the GenAI Interface 508, a moderating sub-system may implement any additional content moderation and may view statistics pertaining to any default content moderation (e.g., performed in accordance with various jurisdictions' laws or regulations). Further, each client device 525 may define an additional constraint to be imposed on utterances 502a and/or data access. It will be appreciated that each such additional constraint may be evaluated to ensure that it accords with system-level constraints and is consistent with data privacy, data security, data integrity, etc. Thus, in some embodiments, when the request payload 550 is received, generating a response payload 551 may include evaluating baseline requirements (e.g., based on applicable laws and/or regulations) and using an independent API that combines filtering chatbot messages and filtering user messages. In addition, or alternative, various flags may be used to predict whether a message is from a user or a chatbot, as filtering bot messages may be of higher priority.

In some examples, once the prompts are validated by the content moderator, the validation handler 510 may return an error if a problem was detected in the request payload 550 (e.g., by way of request handler 511) or the response payload (e.g., by way of the response handler 512). The request handler 511 and/or the response handler 512 may be sub-functions/modules/routines of the validation handler 510. In addition, or alternatively, upon detecting a problem in the request payload 550, the validation handler 510 may recommend a revised utterance to the user. Upon detecting a problem in the request payload 550, the validation handler 510 may iteratively route corresponding utterances to one or more other GenAI Providers 503 and/or may generate an updated utterance for a same GenAI Model 505, where the updated utterance may be generated to include a component that corresponds to an instruction or clarification (e.g., via VFD LLM Component 516) to avoid the detected problem. For this purpose, the validation handler 510 may offer a prompt designer module (included in the prompt module 514) in which prompts can be dynamically analyzed in a step-by-step fashion, and feedback can be provided in real-time. The analysis may include transforming a prompt to detect both a system instruction and the utterance 502a that are to collectively be provided to the GenAI Model 505. The system instruction and utterance 502a, as detected, can be dynamically provided via an interface in real-time, such that the user can revise the prompt and/or edit the system instruction and/or user input. The prompt designer may forward the validated prompts to GenAI Model Providers 503 through APIs. The GenAI Interface 508 may process the request payload 550 using natural language processing capabilities and relay the request payload 550 to the GenAI Providers 503.

In some embodiments, the GenAI Interface 508 selects one or more GenAI Model Providers 503 that may be capable in providing a full and adequate response to the utterance 502a. However, many GenAI Providers 503 take specific inputs and may not always be receptive to any arbitrary input. One example of a GenAI Model Provider is OpenAI™ which has a preferred prompt format and an unpreferred prompt format shown here:
i) Preferred Format:
   “Extract the important entities mentioned in the text below. First extract all company names, then extract all people names, then extract specific topics which fit the content and finally extract general overarching themes:

```
      Desired format:
      company names: <comma_separated_list_of_company_names>
      People names: -||-
      Specific topics: -||-
      General themes: -||-
      Utterance: {Johnny works at CarpetCo. And Jane works at TileCorp. Matt
would like to work in the tile industry, but only has skills in the carpet industry.}”
  ii) Not Preferred Format:
    “Extract the entities mentioned in the text below. Extract the following 4 entity
types: company names, people names, specific topics and themes:
      Utterance: {Johnny works at CarpetCo. And Jane works at TileCorp. Matt
would like to work in the tile industry, but only has skills in the carpet industry.}”
```

The GenAI Interface 508 may create the custom request body specification based on the GenAI Providers 503 preferred format which is stored on memory or communicated by the GenAI Providers 503 to the GenAI Interface 508. Once the GenAI Interface 508 selects the appropriate GenAI Model Providers 503, the request/response transformer 513 converts the common request body specification, which is part of the request payload 550, into a custom request body specification in order communicate the request payload 550 to the selected GenAI Provider 503 including a preferred prompt style (as discussed above). The custom request body specification may include the utterance 502a and details that were present in the common request body specification but catered, and/or tailored to a preferred format/style for the selected AI Provider 503. For example, the GenAI Interface 503 may use the request/response transformer 513 in order to take the utterance 502 of “I'm forty-three and I would like to know what my options are for 401k investment strategies for a target retirement by sixty years old.” and transform it into the custom request body specification:

“Your persona is that of a retirement financial adviser. Extract the important entities mentioned in the text below. First identify all relevant federal regulations and policy, then retrieve retirement program information, then identify specific topics which fit the content and finally extract general overarching themes:

```
  Desired format:
  Retirement options: <bullet_point_list_of_retirement_options>
  Alternative options: -||-
  Detailed Summary of Retirement Options: -||-
  Federal Aid Programs: -||-
  Model: ChatGPT
  Temperature: 0
  Max_tokens: maximum value
  Utterance: {I'm forty-three and I would like to know what my options
  are
for 401k investment strategies for a target retirement by sixty years old.}”.
```

The GenAI Providers 503 then relay the request payload, which includes the custom request body specification, to one or more GenAI Models 505. If more than one GenAI Provider 503 is selected, multiple custom request body specifications are sent the GenAI Providers 503. In some examples, some custom body specifications, by way of the request payload, sent to GenAI Models 505 may result in a response that is unsatisfactory. This is more problematic with stateless models (e.g., LLM (stateless)), which may fail to capture a state of a prior interaction that was not satisfactory. In some instances, history (e.g., previous prompts, custom body request specifications, etc.) is embedded in the prompt using various encoding techniques. In some instances, historical response assessments performed at the cloud-computing platform (e.g., cloud computing platform 401 with respect to FIG. 4) are used to dynamically rank or score each of GenAI Models 505, via GenAI Providers 503, with respect to any new utterances based on a predicted response quality and/or likelihood that a response will be free of errors (as detected by the validation handler 510 or as determined based on user feedback).

In some examples, GenAI Interface 508 includes an error handling service to responses in the cloud environment. By way of example, the validation handler 510 is used to validate a response (e.g., a JSON file) representing a custom response payload 55 sent from the GenAI Model 505, via the GenAI Provider 503, against criteria imposed in an initial utterance 502a. If a validation is not satisfied, additional event handler logic can be used to further process the response to facilitate accurate translation into the desired format (e.g., by way of request/response transformer 513) such as JSON. Error tracking can be complicated when the cloud environment interfaces with a GenAI Model 505/GenAI Provider 503. An error may be due to an improper prompt, a validation error, a system unavailability, or a data-interpretability error, etc. Due to this uncertainty, a quantity of retries triggered from the validation handler 510 are tracked. This quantity may be returned to the client device 525 as subsequent retries are being prepared for transmission. The user (e.g., developer, customer) may define a rule (and/or modify a default rule) that indicates when retries are to be terminated.

In some examples, multiple runtime checks can be performed confirming a presence of a minimum set of field values are in the output of the GenAI Models 505 (e.g., opportunity name should be in summary, account name, etc.) and confirming that select restricted values are not in the GenAI Model 505 output (e.g., when generating emails: only these email addresses should be in the output). According to some embodiments, using composite bag (CB) entity functionality may avoid too much complexity in configuring the checks within the VFD LLM Component 516. Composite bag entities allow a user and/or developer to write much shorter, more compact dialog flow definitions because they can be resolved using just one component (either Resolve Entities or a Common Response). A user may add a component property, for example, “Composite Bag (CB) Entity for Output Validation” such that when a CB entity is specified in this property, the intent server may be invoked and the GenAI Model 505 output may be used as an entity matching query. The CB items may be populated for which a matching entity value may have been found. The CB item values may then be validated by ensuring that all bag items that have ‘Prompt for Value’ are considered required; enforcing bag item validation rules; and calling the validation handler 510.

In some examples, if validation fails, a session with the VFD LLM component 516 can end, setting a new transition action “outputValidationError”. In another instance, if validation fails, a validation error message may be sent back to the GenAI Models 505, so the GenAI Models 505 can correct the error. The validation error to send can be configured with the CB item or set within a standard entity event handler. This can be restricted to a maximum number of turns to prevent an endless loop. In some examples with streaming being disabled to enable output validation in the first place, waiting time for the user may increase and a means can be provided to allow a user (e.g., skilled developer) to send a “status update” message. This approach may be combined with the validation handler 510 and VFD LLM Component 516 such that a developer may inspect the CB entity (passed in the CB entity as a handler event property), and code any custom logic to validate the GenAI Model 505 response using the entity matches (e.g., discussed in more detail further on) stored in the various bag items. A long GenAI Model 505 response may result in unexpected/wrong entity matches in the CB entity, so a form of prompting (where the criticize prompt might include entity validation instructions) may be used.

In some examples, the GenAI Interface 508 may use the GenAI Models 505 as a supportive tool within, or in conjunction with, business operations, by maintaining at least partial control over the data and how it is used, rather than letting the GenAI Models 505 dictate the information flow. This approach allows them to harness the capabilities of the language model to improve the business processes without letting it define their information needs. The validation handlers 510 ensures that the responses from the GenAI Models 505 meets specific quality and accuracy standards that are set by the business corporations. This can help in maintaining data integrity and reliability to make informed decision-making by using reliable business processes. After receiving the response from the GenAI Model 505, the validation handler 510 may then be enhanced using TypeChat prompt enhancements (in JSON). These enhancements can include formatting LLM-generated text, adding context or metadata to it, or doing additional processing to improve the quality or relevance of the response to a submitted prompt. The enhanced custom response payload (e.g. payload from the GenAI Models 505a, b, etc.), which may now include the original LLM-generated content along with any TypeChat prompt enhancements, may then be sent as a custom response payload 551 to the client device 525 that issued the initial prompt, command, or utterance 502a, assuming no errors have been identified by the validation handler 510.

In some embodiments, the cloud computing platform may utilize a recursive framework for integrating client-associated feedback to improve prompt responses. The cloud computing platform may receive the request payload 550 from the client device 525, and the cloud-computing platform may a query for the same, where the query is then routed to a specific GenAI Model 505. Upon receiving the response from the GenAI Model 505, a representation of the custom response payload 551 is availed to the client device 525 via an interface. The interface is configured to receive feedback about the response. For example, the interface may be configured to receive indications including, but not limited to, an accuracy of the custom response payload 551; a degree to which the custom response payload 551 addressed the query; an extent to which a level of detail in the custom response payload 551 matched that of interest for the request payload 550. This type of feedback may be iteratively received for each custom response payload 551, and an updated request payload 550 may be iteratively generated that converted the feedback into an instruction (e.g., new prompt for GenAI Models 505). For example, content from the initial request payload and a prior response payload may be represented in a context of the query, and an instruction in the query may identify an indicate how a next response is to improve with regard to the feedback. The iterations can proceed until an iteration-termination criterion (which may be defined by a client device, a cloud-computing platform, a developer, etc.) is satisfied.

In some embodiments, the GenAI Interface 508 component can be embedded into a processing flow or directly invoked to facilitate interaction with webpages. The GenAI Interface 508 can detect various components of a website and automatically identify, based on initial client-specific objective information, which portions of the website pertain to the client's objective. For example, a website may include one or more pages, sections, content objects, etc. that are irrelevant with respect to a given client's objective. Such relevancy can be estimated using the GenAI Models 505. The estimated relevancy can then be used to determine how to process, rank, or interact with a webpage.

For some GenAI Models 505 which do not have proper training, knowledge set, or request details, the GenAI Models 505 provide responses as though it is confident of a quality of the response (e.g., hallucinations). This situation is common in out-of-domain (OOD) or out-of-scope (OOS) circumstances referring to the capability of recognizing when a user input or query is unrelated or irrelevant to the intended purpose of the GenAI Models 505. Thus, some embodiments relate to using prompt engineering to request that the GenAI Models 505 indicate, as part of its output, whether or a degree to which the query may request a response that is out of the model's domain or scope. The indication may be used to determine whether to return the custom response payload 551 to the client device 525, whether to reroute the prompt (e.g., custom response body specification including the utterance 502a) to another GenAI Model 505, etc. In some instances, another GenAI Model 505 may be called to provide context and/or information that can be routed to the initial GenAI Model 505 in an updated request payload. According to some embodiments, the GenAI Interface 508 may continuously analyze and monitor the user input to understand their intent within a context by using natural language understanding (NLU) techniques. An effective OOS/OOD detection requires proper context management (e.g., to remember the previous turns in the conversation by assessing whether the current input is in or out of a scope as discussed above). Context management may include maintaining a conversation history and understanding the relationships between previous user inputs and system responses. For OOS or OOD detection, a multi-turn dialog state may be maintained, which includes the current context and conversation history. In these examples, the dialog state may be updated after each user turn and the state helps the LLM to understand the flow of the conversation and to detect when it goes OOS or OOD.

In some examples, a single request is fed to a single GenAI Model 505. However, if the model is not well configured to respond to the request (e.g., due to OOS or OOD reasons), a response can be of poor quality (as determined by response handler 512). Embodiments of the present disclosure may provide the request payload to many models and generate potential response payloads, of which provide many options for review by the response handler 512. A new request payload can then be generated by the request/response transformer 513 and fed to a different GenAI Model 505, where the new request payload provides the initial request, the response options (or a representation thereof), and an instruction to generate an output based on the response options and the request. For example, the instruction may be to select a single response option as a favored option, to rank-order the response options, or to assign a score to each response option. In some instances, this process is repeated multiple times, where—for each iteration—a different GenAI Model 505 is selected to evaluate the new request payload and may be omitted from the set of GenAI Model 505 used to generate the potential response payload options.

According to some embodiments, contextual routes can be used to enable OOS intents routing before invocation of a LLM component. Upon receiving, at a cloud computing platform (e.g., cloud computing platform 401 with respect to FIG. 4), a request payload 550, a set of requests can be generated. Each request can be generated to comply with input-specification criteria (e.g., developer assigned via VFD LLM Component 516 by way of error criteria module 517) of given GenAI Model 505. Each request can provide information about the request as context, and request an estimation as to how well equipped (e.g., in terms of a training experience or knowledge base) the GenAI Model 505 is to respond to the request. As mentioned previously, the requests can be fed to the respective GenAI Models 505, and responses can be received that include the estimated degree of how well-equipped each GenAI Model 505 is to handle the request. When the GenAI Models 505 are equipped with the contextual information, the GenAI Models 505 may generate coherent and contextually relevant responses. However, the quality of these response may depend on how accurately the input context is the provided. For users, providing a platform to perform complex tasks such as multi-tum conversations that involve keeping a track of the complete conversation history and the current state of the conversation, the correct context helps GenAI Models 505 to generate accurate and personalized responses. To understand complex phrases, ambiguous words, or acronyms in the user utterance 502s, GenAI Models 505 may utilize context to disambiguate the ambiguity in user input.

According to some embodiments, various few-shot techniques may be used to respond to and/or address the aforementioned OOS/OOD situations. A few-shot technique can provide a set of exemplary prompts and responses that GenAI Models 505 use to inform themselves as to how to respond to a given request payload. This approach is used to provide information to GenAI Models 505 about a format of response that is expected. In some embodiments, a few-shot technique is used to provide exemplary request-response data that illustrates knowledge or scope that is or might be outside a knowledge or scope domain of the GenAI Models 505. The request payload can then request that a custom response payload 551 is generated consistent with the exemplary request-response data.

In some examples, some third party GenAI Providers 503 are susceptible to data leakage, responding in a problematic manner to malicious input, developing bias, passing disinformation, generating inconsistent responses, lacking interpretability, etc. As a result, the GenAI Interface 508 may interact with multiple different GenAI Providers 503 which have not been previously validated. This approach may facilitate adversarial responses in that one or more GenAI Providers 503 can be recruited (e.g., external sources 607 with respect to FIG. 6) to generate utterances/prompts that test whether and/or an extent to which another GenAI Model 505 generates a response that may be inconsistent with a target performance metric (e.g., no data leakage).

In some examples, the validation handler 510 provides client devices 525 with efficient and optimized SQL queries to offer data analytics services. The GenAI Models 505 can be used to generate SQL dialogs based on user utterances to enhance exploration of data and semantics understanding. For large databases, the GenAI Model Providers 503 may be integrated into a cloud platform (e.g., cloud computing platform 401 with respect to FIG. 4) that can help explain the purpose and structure of a table or data within a database by analyzing its schema and relations. The GenAI Models 505 may provide guidance in exploring the data efficiently and effectively and can suggest relevant tables, columns, or utterances to help users (by way of the DA/Chatbot System 507) extract valuable insights from the dataset that otherwise would require advance business intelligence methods. Thus, explaining the meaning and relationships between tables, columns, and data points to the users who are not familiar with a domain of databases can enable them to use natural language prompts to interact with databases.

Returning now to the functionality of the VFD LLM Component 516, using the GenAI models 505, several capabilities may be included into a dialog flow where suitable (e.g., instances where a new prompt does not have a pre-defined or pre-learned response). The dialog flow component may be the primary integration piece for generative AI in that it contacts the GenAI Model 505 through a call (e.g., a REST call), then sends the GenAI Model 505 a prompt (e.g., natural language instructions to the LLM) along with related parameters (e.g., context, metadata, etc.). The GenAI Model 505 then returns a response generated by the model (which are also known as completions) and manages the state of the GenAI Model 505 so that response may remain in context after successive rounds of user utterances 502a and feedback. In addition, or alternatively, one or more LLM component states 519 (or LLM blocks) may be suitably added and/or removed to flows (e.g., developer added/defined prior to, during, and/or after the request payload 550 being transmitted). Chaining the GenAI Model 505 calls may be performed so that the output of one GenAI Model 505 request can be passed to a subsequent GenAI Model 505 request. GenAI Model 505 integration may include endpoints for the GenAI Model Providers 503, and the request/response transformation handler 513 for converting the request payload 550 and response to and from various GenAI Model Providers 503 formats. In some examples, the request/response transformation handler 513 may include a look-up table (e.g., database) of formats that yield successful responses and/or requested formats per GenAI Providers 503.

In some examples, the request/response transformation handler 513 functions in tandem with the VFD LLM Component 516. For example, a developer may be able to set predefined criteria (e.g., by way of error criteria module 517), the results of which may be passed to the validation handler 510 (e.g., as input and/or output) for processing based on developer configurations (e.g., configuration(s) module 518). For example, the developer may choose to raise an error, transition to another state, or request clarification from the user, or re-prompt the GenAI Model 505 to improve the response payload.

In some examples, the VFD LLM Component 516 receives the response payload from the GenAI Models 505 (e.g., by way of response handler 512). For example, the data within the response payload is generated by the VFD LLM Component 516 using one or more predicted completions (e.g., messages). The data may be represented based on JSON syntax and contain some, none, or all properties that the request payload 550 included. In some examples, a set of candidate messages may be batched into a list of response items, to reduce the number of validation handler 510 calls.

In some examples, the validation handler 510 may determine that the response payload from the GenAI Models 505, via the GenAI Providers 503, may include errors, successfully completion, processing instructions, or combinations thereof. For example, an error response body specification may be generated when a REST call returns a HTTP status other than HTTP 200-Status (e.g., data is represented based on JSON). The one or more errors may be transformed from the GenAI Models 505 specific format for the given GenAI Model 505 and/or GenAI Interface 508 into an error body specification (e.g., a common response body specification). Some examples of errors provided in the error body specification may include, but are not limited to:
i) notAuthorized
ii) modelLengthExceeded
iii) requestFlagged
iv) responseFlagged
v) requestInvalid
vi) responseInvalid
vii) unknown.

i) notAuthorized: Indicates the GenAI Model 505 request does not have proper authorization key.

ii) modelLengthExceeded: Indicates that the combination of request payloads (system prompt plus user and assistant refinement messages) and the maximum number of tokens exceeds the GenAI Models 505 maximum supported length.

iii) requestFlagged: Indicates that the GenAI Model 505 request payload is against the moderation policies of the GenAI Model 505, for example when the request contains regulated content.

iv) responseFlagged: Indicates that the GenAI Model 505 response payload is against the moderation policies of the GenAI Model 505, for example when the response contains regulated content.

v) requestInvalid: Indicates that the request payload is invalid, for example because it failed some validation rules set in the validation handler, or the format is not understood by the GenAI Model 505.

vi) responseInvalid: Indicates that the response payload is invalid, for example because it failed some validation rules set in the validation handler.

vii) unknown: Unknown error.

In some examples, the validation handler 510 may validate an input (e.g., JSON input), or request payload, representing the prompt sent to the GenAI Model 505 or a response payload from the GenAI Model 505, respectively, against predefined criteria such as criteria stored in the error criteria module 517. If a validation is not satisfied, additional validation handler 510 logs may be used to further process the input or response to facilitate accurate translation into the correct format (e.g., JSON, etc.). In some examples, an error may be due to an improper prompt, a validation error, a system unavailability, or a data-interpretability error, etc. Due to this uncertainty, a quantity of retires triggered from the validation handler 510 may be tracked periodically, according to a schedule, or substantially in real-time. The quantity of retries may be returned to the DA/Chatbot System 507 and/or the client device 525 as subsequent retires are prepared for transmission. A developer may define a rule (and/or modify a default rule) that indicates when retries are to be terminated (e.g., by way of developer pathways 522 and VFD LLM component 516). In addition, or alternatively, the user may define the rules as well.

In some examples, functions for the validation handler 510 may be written during the creation of the validation handler 510. A service validation handler (e.g., a REST service) may be created by way of an interface (e.g., GUI of the DA/Chatbot System 507) and/or a Bots-Node-SDK Command Line Interface (e.g., an Oracle Bots-Node-SDK Command Line Interface). By way of example, a first argument of each event method may be an event object. The properties available in this event object may depend on a type of event. A second argument of each event method may include a context object. The object may reference a GenAI Model 505 context function (e.g., LLMContext) that may provide access to create the functions for the validation handler 510.

In some examples, the validation handler 510 may include, without limitation, several functions. For example, the validation handler 510 may include a validateRequestPayload function to validate or invalidate the request payload 550 to fix a prompt (e.g., prompt associated with utterance 502a) and send the prompt to the GenAI Model 505, and/or set a validation error. The validation handler 510 may also include a validateResponsePayload function that may validate or invalidate a response payload from the GenAI Models 505 that may retry sending the request payload 550 by invoking the GenAI Models 505 again using a retry prompt that specifics what was wrong and asking the GenAI Model 505 to fix it, for example because the response payload does not conform to a specific format (e.g., JSON, preferred prompt format, etc.) that was requested in the initial prompt. In addition, or alternatively, a validation error may be defined (discussed in more detail further on).

In some examples, if the validation handler 510 has provided a modelLengthExceeded error code, the VFD LLM Component 516 may try to automatically handle the error by performing, without limitation, a check if there are previous refinement turns in the chat history within the LLM component state 519 were invoked. For example, when a GenAI Model 505 has returned a response payload, and the user or developer has requested a refinement, and the GenAI Model 505 returned a new version of the response payload. In an instance when previous refinement turns exist, one or more components of the VFD LLM Component 516 may remove the oldest refinement turn, which may include a user refinement message and GenAI Interface 508 “response”, and invoke the GenAI Model 505 again. The “loop” may continue until the GenAI Models 505 succeeds or when there are no more prior refinement turns to remove. In addition, or alternatively, if the GenAI Model 505 is unable to provide an adequate response (e.g., continues to fail while there are no refinement turns), the error transition action may be set and the error may be stored as a context variable for future reference. In some examples, the number of retries trigger from event handlers may allow the user and/or developer to easily check the number of retries that have been done before prior to attempting another retry prompt.

In some embodiments, the GenAI Interface 508 executes one or more actions responsive to determining that the response payload from the GenAI Providers 503 includes an error or invalid data (e.g., as discussed previously). The GenAI Interface 508 includes an action module(s) 520 and other action module(s) 521. The action module(s) 520 performs an operation when the error or invalid data is determined to exist in the response payload. The operation may include, without limitation, modifying the request payload based on the error or invalid data to generate a modified request payload where the modified request payload may include an instruction that informs the GenAI Model Providers 503, the GenAI models 505, or both of missing matches and requests that the GenAI Model Providers 503, the GenAI Model 505, or both to revise the response payload to include the values for the entities associated with missing matches, and communicating the modified request payload to the GenAI Model Providers 503 for processing by the GenAI model 505, notifying the user of the error or invalid data, transmitting a notification to the client device 525 of the error or invalid data, logging of the error or invalid data in memory, modifying the request payload based on the error or invalid data to generate a modified request payload such that the modified request payload includes an instruction that informs the GenAI Model Providers 503, the GenAI Model 505, or both of the error or invalid data and requests that the GenAI Model Providers 503, the GenAI Model 505, or both correct the error or invalid data, modifying the response payload based on the error or invalid data to generate a modified response payload such that the modified response payload includes and instruction that informs the GenAI Model Providers 503, the GenAI Model 505, or both of the error or invalid data and requests that the GenAI Model Providers 503, the GenAI Model 505, or both correct the error or invalid data, or combinations thereof.

In some embodiments, the other action module(s) 521 may perform an operation when the error or invalid data is not found in the response payload. For example, the operation may include, without limitation, transmitting the custom response payload to the client device 525, logging the custom response payload data in memory, communicating the successful response payload to the GenAI Model Providers 503 for processing by the GenAI Model 505 for training, or combinations thereof.

FIG. 6 illustrates an example swim diagram 600 for a DA/Chatbot System, according to some embodiments. While various processes and operations are depicted in FIG. 6, certain steps, processes, techniques, or methods may be omitted for clarity, it should not be considered limiting and any suitable number of steps, processes, techniques, or methods may be implemented. The swim diagram 600 may begin at one or more client device(s) 601 (e.g., users of DA 108 with respect to FIG. 1) providing an utterance 610 to a DA/Chatbot System 603. For example, an end-user (or developer) may provide a question to the DA/Chatbot System 603 via a web interface (e.g., GUI) such as an airline storefront, such as “I'd like to book a flight from Wilmington North Carolina to Seattle Washington that has in-flight action movies. I'd also like to find breakfast near my hotel in Seattle that is open early on Sundays and I'd like to book a theater play that isn't too dramatic for Sunday evening”. The DA/Chatbot System 603 may identify that the utterance 610 may be OOS of pre-existing deterministic replies (e.g., by way of master bot 114 and/or skill bots 116 with respect to FIG. 1). In this example, the DA/Chatbot System 603 generates a request payload 611, based at least in part on the utterance 610, and invokes a GenAI Interface 604 (e.g., GenAI Interface 508 with respect to FIG. 5).

In some examples, the GenAI Interface 604 generates the request payload 611 having a common request body specification that may be in a standard format (e.g., messages, streamResponse, temperature, etc.) to interact with one or more GenAI Model Providers 605 that are be able to assist with the OOS scope of the utterance 610. The GenAI Interface 604 may identify the GenAI Model Providers 605 that may be able to handle at least a portion of the utterance 610. For example, the DA/Chatbot System 603, using the GenAI Interface 604, may identify different intents (e.g., by way of multiple intent subsystem 220 with respect to FIG. 2) and select appropriate providers. In this example, the GenAI Interface 604 may select a provider that may have models (e.g., GenAI Model(s) 606) trained on booking events, a provider that may trained on recommending food, and a provider that may have models trained on entertainment (e.g., providers 613a-613c). The GenAI Interface 604 may convert the common request body specification into one or more custom request body specifications (e.g., custom requests 612) having specific formats (e.g., data input format) associated with each of the selected GenAI Model Providers 605. In some examples, since each GenAI Model Provider 605 may have custom requirements for receiving input, the GenAI Interface 604 creates custom request payloads to ensure that the GenAI Model Providers 605 get the common request body specification in a correct format (e.g., includes correct fields, properly formatted, intents identified).

Continuing this example, the GenAI Interface 604 performs error handling 604a on the custom requests 612 for one or more errors (as discussed with respect to FIG. 5) prior to communicating the custom requests 612 to the GenAI Model Providers 605. Once the outgoing custom requests 612 have passed error checks, the GenAI Interface 604 communicates the request payload 611 with the custom request body specification (e.g., custom requests 612) to the selected GenAI Provider(s) 605 for processing. The GenAI Model Provider 605 may in turn relay the custom requests 612 to selected GenAI Models (not depicted, GenAI Models 505 with respect to FIG. 5). Each of the GenAI Models attempt to process the custom request body specifications according to the respective LLM models utilized and provide one or more response payloads (e.g., responses 614). For example, the GenAI Models each provide a response 614 to the GenAI Model Providers 605, respectively. Each of the responses 614 may include a response to some or all of the utterance 610 and/or a prompt generated based on the utterance 610 (as discussed with respect to FIG. 5). In addition, or alternatively, the responses 614 may include answers, questions, prompts, clarifications, or similar, in response to the utterance 610. For example, a first selected GenAI Model 613 may provide a response 614 similar to, “Here is a list of flights available to book from Wilmington to Seattle in the next five business days. I do not have information on what in flight movies may be available for these flights but the AirplaneCorp 121 model does provide in flight entertainment. Here is a link to a trusted booking website: airplanecorp/flightbookings/wilmington2seattle” while a second selected GenAI Model 613 may provide a response that includes general information about planes, flights, and entertainment, but does not provide a direct response to any of the questions. In addition, or alternatively, a third selected GenAI Model 613 may provide an error instead of a response. In various embodiments, the GenAI Model Providers 605 may not process the custom requests 612 prior to determining that each payload does not contain an error.

In some examples, the GenAI Model Providers 605 may relay the responses 614 from the GenAI Models 606 to the GenAI Interface 604 for further processing. By way of example, some of the response payloads 614 may be associated with, without limitation, an error, a validation, a request for more information, or combinations thereof. As discussed above, in a non-limiting example, the third selected GenAI Model 613 may have provided an error associated with processing the custom request payloads 612 which is detected via error handling 604a of the GenAI Interface 604 (e.g., validation handler 510 with respect to FIG. 5). For example, for the utterance 610, “I'd like to book a flight from Wilmington North Carolina to Seattle Washington that has in-flight action movies. I'd also like to find breakfast near my hotel in Seattle that is open early on Sundays and I'd like to book a theater play that isn't too dramatic for Sunday evening”, the GenAI Models may have provided the following responses:
GenAI Model A: “Here is a list of flights available to book from Wilmington to Seattle in the next five business days. Tuesday 8 PM, Wednesday 5 AM, Friday 10 AM.”
GenAI Model B: “Here is a link to a trusted booking website: airplanecorp/flightbookings/wilmington2seattle”
GenAI Model C: “Invalid question. Error 212.”
GenAI Model D: “Here is a list of flights available to book from Wilmington to Seattle in the next five business days. Tuesday 8 PM, Wednesday 5 AM, Friday 10 AM. Here is a link to a trusted booking website: airplanecorp/flightbookings/wilmington2seattle. Each of these flights have in-flight action movies.
WaffleStoreA at LongStreetName is near the Seattle Airport and central to many hotels in the area and opens at 4 AM. It is a mile from your hotel.
DramaPlay9 located at ShortStreetName is near Seattle Airport and central to many hotels in the area. Click here to book seats.”

In some examples, the GenAI Interface 604 receives the responses 614 from the GenAI Model Providers 605 and generate one or more custom response body specifications associated with the responses 614. By way of example, the responses 614 may have a format (e.g., data output format) associated with a respective GenAI Model Provider 605 (as discussed above). The responses 614 may be processed by the GenAI Interface 604 to generate custom response body specifications (associated with the respective GenAI Model Provider 605), and then be converted (e.g., transformed) into common response body specification that may be in a standardized format. For example, for GenAI Model D, the response 614 may be converted into the common response body specification:

Here are the results of your question:
“Three flights have been found. {List of all flights}.
One restaurant has been found: {List of all restaurants}
One theater play has been found: {List of all theater plays}.”

The GenAI Interface 604 may then determine whether the responses 614 received, which now include the converted common response body specification, may include an error or invalid data based on an evaluation of the common response body specifications. For example, the GenAI Interface 604 may determine that only one GenAI Model Provider 605 provided an acceptable response to the utterance 610 (e.g., GenAI Model D). In addition, or alternatively, the GenAI Interface 604 may determine that one or more of the GenAI Model Providers 605 provided data which may not be accurate, appears to be incorrect, or may be incomplete, without limitation. Returning to the previously discussed example regarding booking flights, one of the GenAI Model Providers 605 may have responded to a first portion of the utterance 610 (e.g., booking flights) but may not have responded to a second portion of the utterance 610 (e.g., locating breakfast), such as GenAI Model A. In some examples, the GenAI Interface 604 determine that a response from the GenAI Model Provider 605 is too long or too short (e.g., GenAI Model A-C).

In some examples, the GenAI Interface 604 relays one or more custom responses 615, including the common response body specification, to the DA/Chatbot System 603 for one or more actions 602 to be performed. In addition, or alternatively, the GenAI Interface 604 and the DA/Chatbot System 603 may function in tandem to perform the actions 602. For example, when the DA/Chatbot System 603 receives the custom response payload 615, the DA/Chatbot System 603 and/or the GenAI Interface 604 may determine that the results need further assessment (e.g., an error was returned, invalid data, etc.). The DA/Chatbot System 603 may relay the results to the client device(s) 601, including if the results include errors and/or invalid data (e.g., as in GenAI Model C), or may withhold the results until the error/invalid data are addressed. In instances where there the custom response payload 615, containing the common response body specification, is determined acceptable, the DA/Chatbot System 603 may notify the client device(s) 601 of the results.

According to some embodiments, the DA/Chatbot System 603 and/or the GenAI Interface 604 identifies the error in the response 614 and performs one or more actions 602 including error handling 615a. This results in generating a new request with new parameters (e.g., matches, entities, prompts, custom request body specifications, etc.) and passing the new request with the new parameters through the process again to generate new requests/responses 615c to the GenAI Providers 605 for subsequent GenAI Models to process. The new requests/responses 615c will re-enter the process for validation (e.g., validation handler 510 processes with respect to FIG. 5). The results are passed back to the validation handler of the GenAI Interface 604 for further error handling 615b (similar or the same as error handling 615a as discussed in more detail with respect to FIG. 5). Subsequently, the responses are passed back the DA/Chatbot System 603 to determine if further actions 602 may be necessary by converting the custom response body specifications to common response body specifications (e.g., common response 630 as discussed with respect to FIG. 5). If the common response body specifications of the common response 630 are determined to be accurate, precise, or reliable, the common responses 630 is passed back to the client device 601 as a response from the DA/Chatbot System 603.

Returning now to the discussion of an occurrence where an error is determined to exist in the response, determining whether the response (e.g., custom response 615) includes an error or invalid data may include an accuracy validation step where the DA/Chatbot System 603 and/or the GenAI Interface 604 may request a third party evaluation of the common response body specification by way of external validation 616 by an authoritative external sources 607. Validation may be performed by i) retrieving information from the one or more authoritative external sources 607 to confirm accuracy of the response payload, ii) assessing whether the response maintains contextual integrity, ensuring that the response payload is appropriate and relevant within a given context, iii) identifying errors or inconsistencies in the response payload based on a list of errors or inconsistencies, iv) generating a reasoning chain or step-by-step explanation and validating whether the response payload follows the reasoning or explanation, or any combination thereof.

According to some embodiments, the authoritative external sources 607 may provide an external source response 617 that may, at least in part, validate and/or invalidate some or all of the common response body request and provide a validation response 618 to the DA/Chatbot System 603. The authoritative external sources 607 may provide a suggestion, information, a detailed response, or otherwise actionable data that may facilitate the DA/Chatbot System 603 in determining an action to take. For example, the DA/Chatbot System 603 may redo the process using modified or otherwise customized data to be used to create a new request payload to be provided to the GenAI Model Providers 605. In other examples, the common body response payload may be appended with information from the external source response 617 to generate a modified/verified response payload 620 to be relayed to the client devices 601 and/or used to perform the actions 602.

According to some embodiments, determining whether the response payload includes an error or invalid data may include comparing values for entities with data in the response payload (e.g., custom response payload 615), evaluating, based on the comparing, whether there any missing matches between the values for the entities and the data in the response payload, or responsive to determining there are missing matches, determining whether the missing matches are indicative of the error or invalid data.

FIG. 7 illustrates an example method 700 for using a generative artificial intelligence interface accordance with various embodiments. It should be readily recognized that the method may include more or fewer steps than is depicted, and the steps may be performed in any suitable order. The example method 700 may be performed by some or all components by any device, system, apparatus of FIGS. 1-5 and 8-12, and may include any suitable number steps as in FIG. 6.

The method 700 may begin at step 705 where a digital assistant (DA) chatbot system generates a request payload (e.g., request payload 550 with respect to FIG. 5, a JSON, etc.) having a common request body specification based on an utterance (e.g., utterance A 202 with respect to FIG. 2). The utterance may be from a user of the DA chatbot system (e.g., users of DA 108 with respect to FIG. 1). The common request body specification may be formatted in a standardized data input format to be used by a generative artificial intelligence (GenAI) interface (e.g., GenAI Interface 408 with respect to FIG. 4) for interfacing, and/or otherwise suitably interacting with a plurality of GenAI Model Providers (e.g., GenAI Model Providers 605 with respect to FIG. 6).

The method 700 may continue at step 710, the GenAI Interface converts the common request body specification into a custom request body specification having a data input format associated with a GenAI Model Provider selected from the plurality of GenAI Model Providers. In a non-limiting example, a user using a website including a chatbot (e.g., master bot 114 with respect to FIG. 1) may provide the chatbot with an utterance, requesting information on the newest hybrid electric car and where to buy one, the GenAI Interface may select a GenAI Model Provider which is capable of providing an accurate and reliable response if the DA chatbot system may be unable to provide such a response. In this example, OpenAI™ may be selected as the GenAI Model Provider to utilize one or more large language models (e.g., ChatGPT, GPT-4, etc.) to provide a response to the utterance of the newest hybrid electric cars. However, due to using the DA chatbot system, the format of the utterance may not be in the correct format for the GenAI Model Provider. Thus, the common request body specification is converted into the custom request body specification having data catered to the GenAI Model Provider (e.g., a preferred format for OpenAI™).

At step 715, the GenAI Interface then communicates the request payload, which includes the custom request body specification, to the GenAI Provider (e.g., Cohere™, OpenAI™, etc.) for processing by a GenAI Model (e.g., ChatGPT). In some examples, multiple custom request body specifications are be generated for multiple GenAI Providers. In addition, or alternatively, the GenAI Interface generates variations in the custom request body specifications to receive various responses for comparisons.

At step 720, the GenAI Interface receives one or more response payloads from the selected GenAI Model Providers. The response payloads may be representative, and/or, include information related to the GenAI Models processing the custom request body specification. In some examples the response payload are associated with an error, processing the request payload, or both.

At step 725, the GenAI Interface generates a custom response body specification associated with the response payload. In some examples, the custom response body specification includes a data output format associated with one or more of the GenAI Model Providers.

At step 730, the GenAI Interface converts the custom response body specification associated with the response payload into a common response body specification. In some examples the common response body specification is a standardized data output format used by the GenAI Interface for interacting with the plurality of GenAI model providers so that error determination may be performed.

At step 735, the GenAI Interface determines whether the response payload includes an error or invalid data based on an evaluation of the common response body specification. In some examples, the error is an incoherent response, a response which may not include enough information, or in some examples, too much information. In addition, or alternatively, the error is a response that is out of scope (OOS) for a particular GenAI Model and that one or more actions may need to be performed in order to achieve the desired results (discussed in detail further on). In some examples, determining whether the response payload includes an error or invalid data includes generating, by another artificial intelligence model, information concerning presence or absence of the error or invalid data within the common response body specification. In some embodiments, generating is performed by: (i) retrieving information from one or more authoritative external sources to confirm accuracy of the response payload, (ii) assessing whether the response maintains contextual integrity, ensuring that the response payload is appropriate and relevant within a given context, (iii) identifying errors or inconsistencies in the response payload based on a list of errors or inconsistencies, (iv) generating a reasoning chain or step-by-step explanation and validating whether the response payload follows the reasoning or explanation, or any combination thereof.

In some examples, determining whether the response payload may include an error or invalid data includes comparing values for entities with data in the response payload. For example, for an intent to order a pepperoni pizza using a web interface (e.g., an utterance to order a pizza), an “OrderPizza” intent, for example, may describes a user request, but only in general terms. To fill in the specifics, this intent may augmented by a “PizzaSize” entity, which identifies values like large, medium, and small from the user input. There may be two types of entities, both of which may be declared as variables in the dialog flow: built-in entities that the DA Chatbot system may provide the user and custom entities, which the user may add on their own. Built-in entities match common types of information like dates, times, and numbers. Custom entities, like the “PizzaSize” entity example, are specific to the skill's domain (e.g., scope of skill bot 116 with respect to FIG. 1). Evaluating, based on the comparing, whether there any missing matches between the values for the entities and the data in the response payload may yield one or more errors. Responsive to determining there are missing matches (e.g., a response which includes pepperoni pizza, but not a medium size pepperoni pizza), determining whether the missing matches are indicative of the error or invalid data.

At step 740, the GenAI Interface executes one or more actions for handling the error or execute one or more other actions for processing the response payload. In some examples, the actions may include modifying the request payload based on the error or invalid data to generate a modified request payload such that the modified request payload may include an instruction that informs the GenAI model provider, the GenAI model, or both of the missing matches (as discussed above) and requests that the GenAI model provider, the GenAI model, or both to revise the response payload to include the values for the entities associated with missing matches. In addition, or alternatively the GenAI Interface may communicate the modified request payload to the GenAI model provider for processing by the GenAI model. The process may repeat any suitable number of times according to a schedule, duty cycle, frequency, or by request.

### Illustrative Systems

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 8 is a block diagram 800 illustrating an example pattern of an IaaS architecture, according to at least one embodiment. Service operators 802 can be communicatively coupled to a secure host tenancy 804 that can include a virtual cloud network (VCN) 806 and a secure host subnet 808. In some examples, the service operators 802 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 806 and/or the Internet.

The VCN 806 can include a local peering gateway (LPG) 810 that can be communicatively coupled to a secure shell (SSH) VCN 812 via an LPG 810 contained in the SSH VCN 812. The SSH VCN 812 can include an SSH subnet 814, and the SSH VCN 812 can be communicatively coupled to a control plane VCN 816 via the LPG 810 contained in the control plane VCN 816. Also, the SSH VCN 812 can be communicatively coupled to a data plane VCN 818 via an LPG 810. The control plane VCN 816 and the data plane VCN 818 can be contained in a service tenancy 819 that can be owned and/or operated by the IaaS provider.

The control plane VCN 816 can include a control plane demilitarized zone (DMZ) tier 820 that acts as a perimeter network (e.g., portions of a corporate network between the corporate intranet and external networks). The DMZ-based servers may have restricted responsibilities and help keep breaches contained. Additionally, the DMZ tier 820 can include one or more load balancer (LB) subnet(s) 822, a control plane app tier 824 that can include app subnet(s) 826, a control plane data tier 828 that can include database (DB) subnet(s) 830 (e.g., frontend DB subnet(s) and/or backend DB subnet(s)). The LB subnet(s) 822 contained in the control plane DMZ tier 820 can be communicatively coupled to the app subnet(s) 826 contained in the control plane app tier 824 and an Internet gateway 834 that can be contained in the control plane VCN 816, and the app subnet(s) 826 can be communicatively coupled to the DB subnet(s) 830 contained in the control plane data tier 828 and a service gateway 836 and a network address translation (NAT) gateway 838. The control plane VCN 816 can include the service gateway 836 and the NAT gateway 838.

The control plane VCN 816 can include a data plane mirror app tier 840 that can include app subnet(s) 826. The app subnet(s) 826 contained in the data plane mirror app tier 840 can include a virtual network interface controller (VNIC) 842 that can execute a compute instance 844. The compute instance 844 can communicatively couple the app subnet(s) 826 of the data plane mirror app tier 840 to app subnet(s) 826 that can be contained in a data plane app tier 846.

The data plane VCN 818 can include the data plane app tier 846, a data plane DMZ tier 848, and a data plane data tier 850. The data plane DMZ tier 848 can include LB subnet(s) 822 that can be communicatively coupled to the app subnet(s) 826 of the data plane app tier 846 and the Internet gateway 834 of the data plane VCN 818. The app subnet(s) 826 can be communicatively coupled to the service gateway 836 of the data plane VCN 818 and the NAT gateway 838 of the data plane VCN 818. The data plane data tier 850 can also include the DB subnet(s) 830 that can be communicatively coupled to the app subnet(s) 826 of the data plane app tier 846.

The Internet gateway 834 of the control plane VCN 816 and of the data plane VCN 818 can be communicatively coupled to a metadata management service 852 that can be communicatively coupled to public Internet 854. Public Internet 854 can be communicatively coupled to the NAT gateway 838 of the control plane VCN 816 and of the data plane VCN 818. The service gateway 836 of the control plane VCN 816 and of the data plane VCN 818 can be communicatively coupled to cloud services 856.

In some examples, the service gateway 836 of the control plane VCN 816 or of the data plane VCN 818 can make application programming interface (API) calls to cloud services 856 without going through public Internet 854. The API calls to cloud services 856 from the service gateway 836 can be one-way: the service gateway 836 can make API calls to cloud services 856, and cloud services 856 can send requested data to the service gateway 836. But, cloud services 856 may not initiate API calls to the service gateway 836.

In some examples, the secure host tenancy 804 can be directly connected to the service tenancy 819, which may be otherwise isolated. The secure host subnet 808 can communicate with the SSH subnet 814 through an LPG 810 that may enable two-way communication over an otherwise isolated system. Connecting the secure host subnet 808 to the SSH subnet 814 may give the secure host subnet 808 access to other entities within the service tenancy 819.

The control plane VCN 816 may allow users of the service tenancy 819 to set up or otherwise provision desired resources. Desired resources provisioned in the control plane VCN 816 may be deployed or otherwise used in the data plane VCN 818. In some examples, the control plane VCN 816 can be isolated from the data plane VCN 818, and the data plane mirror app tier 840 of the control plane VCN 816 can communicate with the data plane app tier 846 of the data plane VCN 818 via VNICs 842 that can be contained in the data plane mirror app tier 840 and the data plane app tier 846.

In some examples, users of the system, or customers, can make requests, for example create, read, update, or delete (CRUD) operations, through public Internet 854 that can communicate the requests to the metadata management service 852. The metadata management service 852 can communicate the request to the control plane VCN 816 through the Internet gateway 834. The request can be received by the LB subnet(s) 822 contained in the control plane DMZ tier 820. The LB subnet(s) 822 may determine that the request is valid, and in response to this determination, the LB subnet(s) 822 can transmit the request to app subnet(s) 826 contained in the control plane app tier 824. If the request is validated and requires a call to public Internet 854, the call to public Internet 854 may be transmitted to the NAT gateway 838 that can make the call to public Internet 854. Metadata that may be desired to be stored by the request can be stored in the DB subnet(s) 830.

In some examples, the data plane mirror app tier 840 can facilitate direct communication between the control plane VCN 816 and the data plane VCN 818. For example, changes, updates, or other suitable modifications to configuration may be desired to be applied to the resources contained in the data plane VCN 818. Via a VNIC 842, the control plane VCN 816 can directly communicate with, and can thereby execute the changes, updates, or other suitable modifications to configuration to, resources contained in the data plane VCN 818.

In some embodiments, the control plane VCN 816 and the data plane VCN 818 can be contained in the service tenancy 819. In this case, the user, or the customer, of the system may not own or operate either the control plane VCN 816 or the data plane VCN 818. Instead, the IaaS provider may own or operate the control plane VCN 816 and the data plane VCN 818, both of which may be contained in the service tenancy 819. This embodiment can enable isolation of networks that may prevent users or customers from interacting with other users', or other customers', resources. Also, this embodiment may allow users or customers of the system to store databases privately without needing to rely on public Internet 854, which may not have a desired level of threat prevention, for storage.

In other embodiments, the LB subnet(s) 822 contained in the control plane VCN 816 can be configured to receive a signal from the service gateway 836. In this embodiment, the control plane VCN 816 and the data plane VCN 818 may be configured to be called by a customer of the IaaS provider without calling public Internet 854. Customers of the IaaS provider may desire this embodiment since database(s) that the customers use may be controlled by the IaaS provider and may be stored on the service tenancy 819, which may be isolated from public Internet 854.

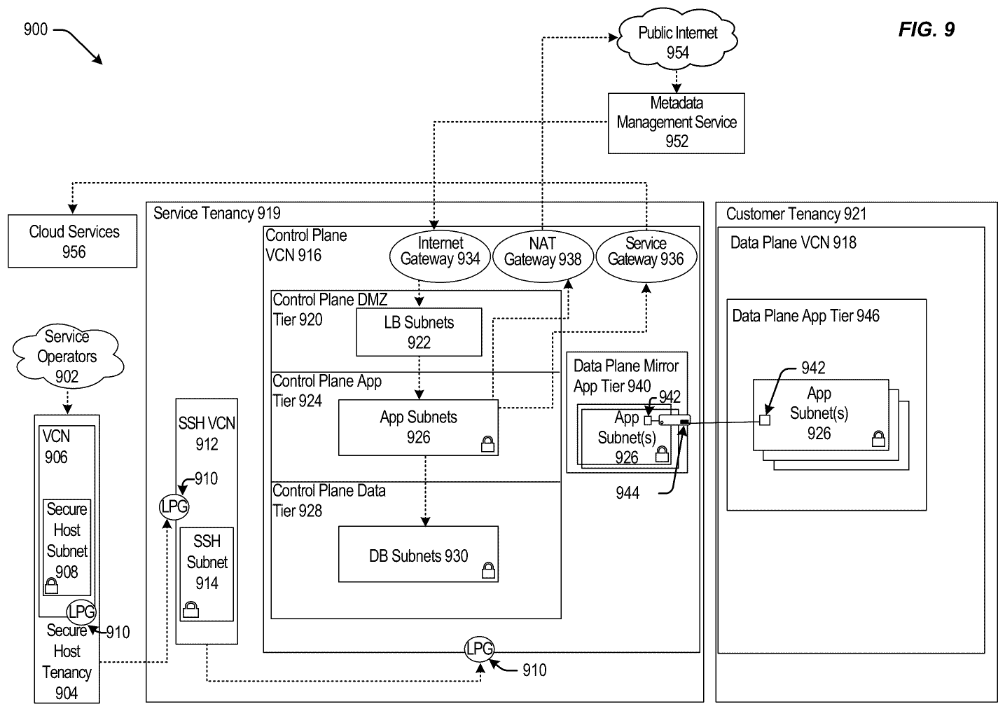

FIG. 9 is a block diagram 900 illustrating another example pattern of an IaaS architecture, according to at least one embodiment. Service operators 902 (e.g., service operators 802 of FIG. 8) can be communicatively coupled to a secure host tenancy 904 (e.g., the secure host tenancy 804 of FIG. 8) that can include a virtual cloud network (VCN) 906 (e.g., the VCN 806 of FIG. 8) and a secure host subnet 908 (e.g., the secure host subnet 808 of FIG. 8). The VCN 906 can include a local peering gateway (LPG) 910 (e.g., the LPG 810 of FIG. 8) that can be communicatively coupled to a secure shell (SSH) VCN 912 (e.g., the SSH VCN 812 of FIG. 8) via an LPG 810 contained in the SSH VCN 912. The SSH VCN 912 can include an SSH subnet 914 (e.g., the SSH subnet 814 of FIG. 8), and the SSH VCN 912 can be communicatively coupled to a control plane VCN 916 (e.g., the control plane VCN 816 of FIG. 8) via an LPG 910 contained in the control plane VCN 916. The control plane VCN 916 can be contained in a service tenancy 919 (e.g., the service tenancy 819 of FIG. 8), and the data plane VCN 918 (e.g., the data plane VCN 818 of FIG. 8) can be contained in a customer tenancy 921 that may be owned or operated by users, or customers, of the system.

The control plane VCN 916 can include a control plane DMZ tier 920 (e.g., the control plane DMZ tier 820 of FIG. 8) that can include LB subnet(s) 922 (e.g., LB subnet(s) 822 of FIG. 8), a control plane app tier 924 (e.g., the control plane app tier 824 of FIG. 8) that can include app subnet(s) 926 (e.g., app subnet(s) 826 of FIG. 8), a control plane data tier 928 (e.g., the control plane data tier 828 of FIG. 8) that can include database (DB) subnet(s) 930 (e.g., similar to DB subnet(s) 830 of FIG. 8). The LB subnet(s) 922 contained in the control plane DMZ tier 920 can be communicatively coupled to the app subnet(s) 926 contained in the control plane app tier 924 and an Internet gateway 934 (e.g., the Internet gateway 834 of FIG. 8) that can be contained in the control plane VCN 916, and the app subnet(s) 926 can be communicatively coupled to the DB subnet(s) 930 contained in the control plane data tier 928 and a service gateway 936 (e.g., the service gateway 836 of FIG. 8) and a network address translation (NAT) gateway 938 (e.g., the NAT gateway 838 of FIG. 8). The control plane VCN 916 can include the service gateway 936 and the NAT gateway 938.

The control plane VCN 916 can include a data plane mirror app tier 940 (e.g., the data plane mirror app tier 840 of FIG. 8) that can include app subnet(s) 926. The app subnet(s) 926 contained in the data plane mirror app tier 940 can include a virtual network interface controller (VNIC) 942 (e.g., the VNIC of 842) that can execute a compute instance 944 (e.g., similar to the compute instance 844 of FIG. 8). The compute instance 944 can facilitate communication between the app subnet(s) 926 of the data plane mirror app tier 940 and the app subnet(s) 926 that can be contained in a data plane app tier 946 (e.g., the data plane app tier 846 of FIG. 8) via the VNIC 942 contained in the data plane mirror app tier 940 and the VNIC 942 contained in the data plane app tier 946.

The Internet gateway 934 contained in the control plane VCN 916 can be communicatively coupled to a metadata management service 952 (e.g., the metadata management service 852 of FIG. 8) that can be communicatively coupled to public Internet 954 (e.g., public Internet 854 of FIG. 8). Public Internet 954 can be communicatively coupled to the NAT gateway 938 contained in the control plane VCN 916. The service gateway 936 contained in the control plane VCN 916 can be communicatively coupled to cloud services 956 (e.g., cloud services 856 of FIG. 8).

In some examples, the data plane VCN 918 can be contained in the customer tenancy 921. In this case, the IaaS provider may provide the control plane VCN 916 for each customer, and the IaaS provider may, for each customer, set up a unique compute instance 944 that is contained in the service tenancy 919. Each compute instance 944 may allow communication between the control plane VCN 916, contained in the service tenancy 919, and the data plane VCN 918 that is contained in the customer tenancy 921. The compute instance 944 may allow resources, that are provisioned in the control plane VCN 916 that is contained in the service tenancy 919, to be deployed or otherwise used in the data plane VCN 918 that is contained in the customer tenancy 921.

In other examples, the customer of the IaaS provider may have databases that live in the customer tenancy 921. In this example, the control plane VCN 916 can include the data plane mirror app tier 940 that can include app subnet(s) 926. The data plane mirror app tier 940 can reside in the data plane VCN 918, but the data plane mirror app tier 940 may not live in the data plane VCN 918. That is, the data plane mirror app tier 940 may have access to the customer tenancy 921, but the data plane mirror app tier 940 may not exist in the data plane VCN 918 or be owned or operated by the customer of the IaaS provider. The data plane mirror app tier 940 may be configured to make calls to the data plane VCN 918 but may not be configured to make calls to any entity contained in the control plane VCN 916. The customer may desire to deploy or otherwise use resources in the data plane VCN 918 that are provisioned in the control plane VCN 916, and the data plane mirror app tier 940 can facilitate the desired deployment, or other usage of resources, of the customer.

In some embodiments, the customer of the IaaS provider can apply filters to the data plane VCN 918. In this embodiment, the customer can determine what the data plane VCN 918 can access, and the customer may restrict access to public Internet 954 from the data plane VCN 918. The IaaS provider may not be able to apply filters or otherwise control access of the data plane VCN 918 to any outside networks or databases. Applying filters and controls by the customer onto the data plane VCN 918, contained in the customer tenancy 921, can help isolate the data plane VCN 918 from other customers and from public Internet 954.

In some embodiments, cloud services 956 can be called by the service gateway 936 to access services that may not exist on public Internet 954, on the control plane VCN 916, or on the data plane VCN 918. The connection between cloud services 956 and the control plane VCN 916 or the data plane VCN 918 may not be live or continuous. Cloud services 956 may exist on a different network owned or operated by the IaaS provider. Cloud services 956 may be configured to receive calls from the service gateway 936 and may be configured to not receive calls from public Internet 954. Some cloud services 956 may be isolated from other cloud services 956, and the control plane VCN 916 may be isolated from cloud services 956 that may not be in the same region as the control plane VCN 916. For example, the control plane VCN 916 may be located in “Region 1,” and cloud service “Deployment 8,” may be located in Region 1 and in “Region 2.” If a call to Deployment 8 is made by the service gateway 936 contained in the control plane VCN 916 located in Region 1, the call may be transmitted to Deployment 8 in Region 1. In this example, the control plane VCN 916, or Deployment 8 in Region 1, may not be communicatively coupled to, or otherwise in communication with, Deployment 8 in Region 2.

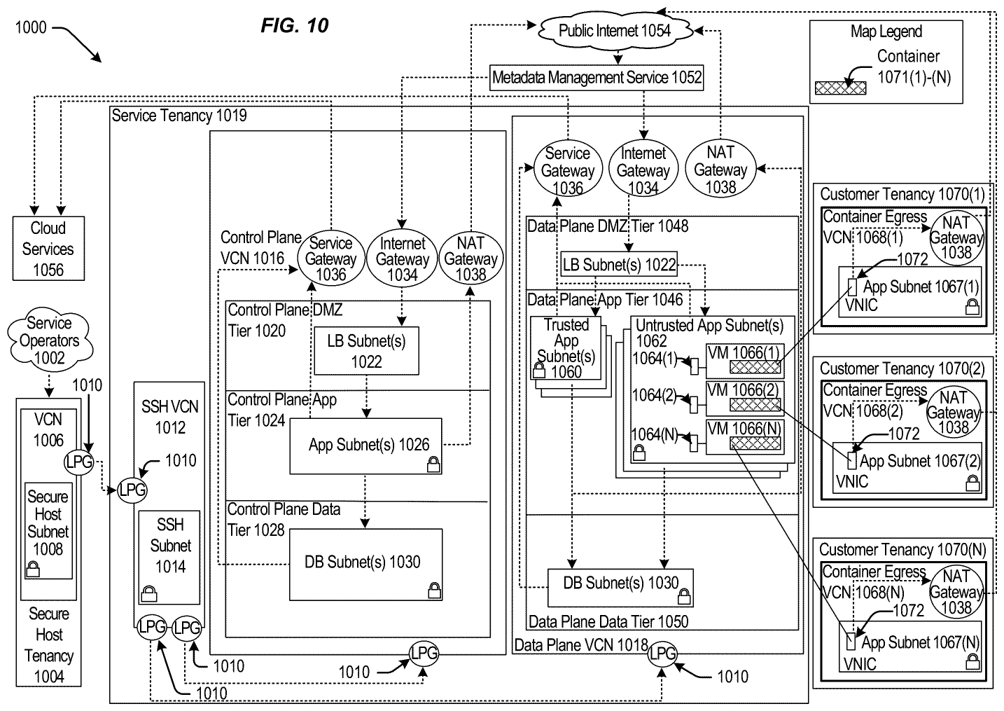

FIG. 10 is a block diagram 1000 illustrating another example pattern of an IaaS architecture, according to at least one embodiment. Service operators 1002 (e.g., service operators 802 of FIG. 8) can be communicatively coupled to a secure host tenancy 1004 (e.g., the secure host tenancy 804 of FIG. 8) that can include a virtual cloud network (VCN) 1006 (e.g., the VCN 806 of FIG. 8) and a secure host subnet 1008 (e.g., the secure host subnet 808 of FIG. 8). The VCN 1006 can include an LPG 1010 (e.g., the LPG 810 of FIG. 8) that can be communicatively coupled to an SSH VCN 1012 (e.g., the SSH VCN 812 of FIG. 8) via an LPG 1010 contained in the SSH VCN 1012. The SSH VCN 1012 can include an SSH subnet 1014 (e.g., the SSH subnet 814 of FIG. 8), and the SSH VCN 1012 can be communicatively coupled to a control plane VCN 1016 (e.g., the control plane VCN 816 of FIG. 8) via an LPG 1010 contained in the control plane VCN 1016 and to a data plane VCN 1018 (e.g., the data plane 818 of FIG. 8) via an LPG 1010 contained in the data plane VCN 1018. The control plane VCN 1016 and the data plane VCN 1018 can be contained in a service tenancy 1019 (e.g., the service tenancy 819 of FIG. 8).

The control plane VCN 1016 can include a control plane DMZ tier 1020 (e.g., the control plane DMZ tier 820 of FIG. 8) that can include load balancer (LB) subnet(s) 1022 (e.g., LB subnet(s) 822 of FIG. 8), a control plane app tier 1024 (e.g., the control plane app tier 824 of FIG. 8) that can include app subnet(s) 1026 (e.g., similar to app subnet(s) 826 of FIG. 8), a control plane data tier 1028 (e.g., the control plane data tier 828 of FIG. 8) that can include DB subnet(s) 1030. The LB subnet(s) 1022 contained in the control plane DMZ tier 1020 can be communicatively coupled to the app subnet(s) 1026 contained in the control plane app tier 1024 and to an Internet gateway 1034 (e.g., the Internet gateway 834 of FIG. 8) that can be contained in the control plane VCN 1016, and the app subnet(s) 1026 can be communicatively coupled to the DB subnet(s) 1030 contained in the control plane data tier 1028 and to a service gateway 1036 (e.g., the service gateway of FIG. 8) and a network address translation (NAT) gateway 1038 (e.g., the NAT gateway 838 of FIG. 8). The control plane VCN 1016 can include the service gateway 1036 and the NAT gateway 1038.

The data plane VCN 1018 can include a data plane app tier 1046 (e.g., the data plane app tier 846 of FIG. 8), a data plane DMZ tier 1048 (e.g., the data plane DMZ tier 848 of FIG. 8), and a data plane data tier 1050 (e.g., the data plane data tier 850 of FIG. 8). The data plane DMZ tier 1048 can include LB subnet(s) 1022 that can be communicatively coupled to trusted app subnet(s) 1060 and untrusted app subnet(s) 1062 of the data plane app tier 1046 and the Internet gateway 1034 contained in the data plane VCN 1018. The trusted app subnet(s) 1060 can be communicatively coupled to the service gateway 1036 contained in the data plane VCN 1018, the NAT gateway 1038 contained in the data plane VCN 1018, and DB subnet(s) 1030 contained in the data plane data tier 1050. The untrusted app subnet(s) 1062 can be communicatively coupled to the service gateway 1036 contained in the data plane VCN 1018 and DB subnet(s) 1030 contained in the data plane data tier 1050. The data plane data tier 1050 can include DB subnet(s) 1030 that can be communicatively coupled to the service gateway 1036 contained in the data plane VCN 1018.

The untrusted app subnet(s) 1062 can include one or more primary VNICs 1064(1)−(N) that can be communicatively coupled to tenant virtual machines (VMs) 1066(1)−(N). Each tenant VM 1066(1)−(N) can be communicatively coupled to a respective app subnet 1067(1)−(N) that can be contained in respective container egress VCNs 1068(1)−(N) that can be contained in respective customer tenancies 1070(1)−(N). Respective secondary VNICs 1072(1)−(N) can facilitate communication between the untrusted app subnet(s) 1062 contained in the data plane VCN 1018 and the app subnet contained in the container egress VCNs 1068(1)−(N). Each container egress VCNs 1068(1)−(N) can include a NAT gateway 1038 that can be communicatively coupled to public Internet 1054 (e.g., public Internet 854 of FIG. 8).

The Internet gateway 1034 contained in the control plane VCN 1016 and contained in the data plane VCN 1018 can be communicatively coupled to a metadata management service 1052 (e.g., the metadata management system 852 of FIG. 8) that can be communicatively coupled to public Internet 1054. Public Internet 1054 can be communicatively coupled to the NAT gateway 1038 contained in the control plane VCN 1016 and contained in the data plane VCN 1018. The service gateway 1036 contained in the control plane VCN 1016 and contained in the data plane VCN 1018 can be communicatively coupled to cloud services 1056.

In some embodiments, the data plane VCN 1018 can be integrated with customer tenancies 1070. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1046. Code to run the function may be executed in the VMs 1066(1)−(N), and the code may not be configured to run anywhere else on the data plane VCN 1018. Each VM 1066(1)−(N) may be connected to one customer tenancy 1070. Respective containers 1071(1)−(N) contained in the VMs 1066(1)−(N) may be configured to run the code. In this case, there can be a dual isolation (e.g., the containers 1071(1)−(N) running code, where the containers 1071(1)−(N) may be contained in at least the VM 1066(1)−(N) that are contained in the untrusted app subnet(s) 1062), which may help prevent incorrect or otherwise undesirable code from damaging the network of the IaaS provider or from damaging a network of a different customer. The containers 1071(1)−(N) may be communicatively coupled to the customer tenancy 1070 and may be configured to transmit or receive data from the customer tenancy 1070. The containers 1071(1)−(N) may not be configured to transmit or receive data from any other entity in the data plane VCN 1018. Upon completion of running the code, the IaaS provider may kill or otherwise dispose of the containers 1071(1)−(N).

In some embodiments, the trusted app subnet(s) 1060 may run code that may be owned or operated by the IaaS provider. In this embodiment, the trusted app subnet(s) 1060 may be communicatively coupled to the DB subnet(s) 1030 and be configured to execute CRUD operations in the DB subnet(s) 1030. The untrusted app subnet(s) 1062 may be communicatively coupled to the DB subnet(s) 1030, but in this embodiment, the untrusted app subnet(s) may be configured to execute read operations in the DB subnet(s) 1030. The containers 1071(1)−(N) that can be contained in the VM 1066(1)−(N) of each customer and that may run code from the customer may not be communicatively coupled with the DB subnet(s) 1030.

In other embodiments, the control plane VCN 1016 and the data plane VCN 1018 may not be directly communicatively coupled. In this embodiment, there may be no direct communication between the control plane VCN 1016 and the data plane VCN 1018. However, communication can occur indirectly through at least one method. An LPG 1010 may be established by the IaaS provider that can facilitate communication between the control plane VCN 1016 and the data plane VCN 1018. In another example, the control plane VCN 1016 or the data plane VCN 1018 can make a call to cloud services 1056 via the service gateway 1036. For example, a call to cloud services 1056 from the control plane VCN 1016 can include a request for a service that can communicate with the data plane VCN 1018.

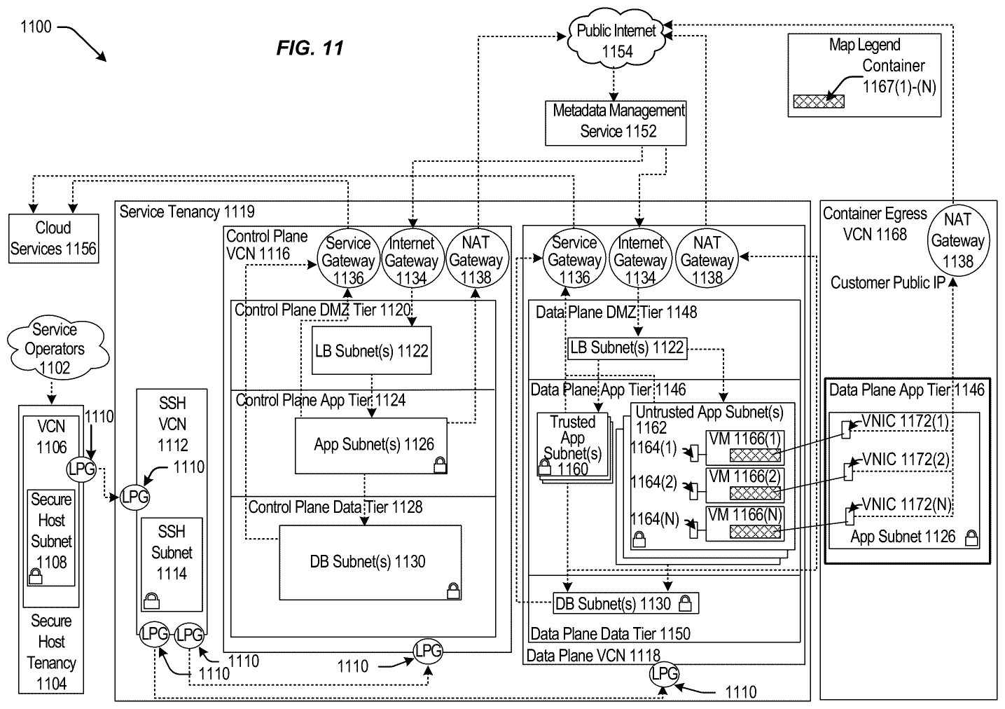

FIG. 11 is a block diagram 1100 illustrating another example pattern of an IaaS architecture, according to at least one embodiment. Service operators 1102 (e.g., service operators 802 of FIG. 8) can be communicatively coupled to a secure host tenancy 1104 (e.g., the secure host tenancy 804 of FIG. 8) that can include a virtual cloud network (VCN) 1106 (e.g., the VCN 806 of FIG. 8) and a secure host subnet 1108 (e.g., the secure host subnet 808 of FIG. 8). The VCN 1106 can include an LPG 1110 (e.g., the LPG 810 of FIG. 8) that can be communicatively coupled to an SSH VCN 1112 (e.g., the SSH VCN 812 of FIG. 8) via an LPG 1110 contained in the SSH VCN 1112. The SSH VCN 1112 can include an SSH subnet 1114 (e.g., the SSH subnet 814 of FIG. 8), and the SSH VCN 1112 can be communicatively coupled to a control plane VCN 1116 (e.g., the control plane VCN 816 of FIG. 8) via an LPG 1110 contained in the control plane VCN 1116 and to a data plane VCN 1118 (e.g., the data plane 818 of FIG. 8) via an LPG 1110 contained in the data plane VCN 1118. The control plane VCN 1116 and the data plane VCN 1118 can be contained in a service tenancy 1119 (e.g., the service tenancy 819 of FIG. 8).

The control plane VCN 1116 can include a control plane DMZ tier 1120 (e.g., the control plane DMZ tier 820 of FIG. 8) that can include LB subnet(s) 1122 (e.g., LB subnet(s) 822 of FIG. 8), a control plane app tier 1124 (e.g., the control plane app tier 824 of FIG. 8) that can include app subnet(s) 1126 (e.g., app subnet(s) 826 of FIG. 8), a control plane data tier 1128 (e.g., the control plane data tier 828 of FIG. 8) that can include DB subnet(s) 1130 (e.g., DB subnet(s) 1030 of FIG. 10). The LB subnet(s) 1122 contained in the control plane DMZ tier 1120 can be communicatively coupled to the app subnet(s) 1126 contained in the control plane app tier 1124 and to an Internet gateway 1134 (e.g., the Internet gateway 834 of FIG. 8) that can be contained in the control plane VCN 1116, and the app subnet(s) 1126 can be communicatively coupled to the DB subnet(s) 1130 contained in the control plane data tier 1128 and to a service gateway 1136 (e.g., the service gateway of FIG. 8) and a network address translation (NAT) gateway 1138 (e.g., the NAT gateway 838 of FIG. 8). The control plane VCN 1116 can include the service gateway 1136 and the NAT gateway 1138.

The data plane VCN 1118 can include a data plane app tier 1146 (e.g., the data plane app tier 846 of FIG. 8), a data plane DMZ tier 1148 (e.g., the data plane DMZ tier 848 of FIG. 8), and a data plane data tier 1150 (e.g., the data plane data tier 850 of FIG. 8). The data plane DMZ tier 1148 can include LB subnet(s) 1122 that can be communicatively coupled to trusted app subnet(s) 1160 (e.g., trusted app subnet(s) 1060 of FIG. 10) and untrusted app subnet(s) 1162 (e.g., untrusted app subnet(s) 1062 of FIG. 10) of the data plane app tier 1146 and the Internet gateway 1134 contained in the data plane VCN 1118. The trusted app subnet(s) 1160 can be communicatively coupled to the service gateway 1136 contained in the data plane VCN 1118, the NAT gateway 1138 contained in the data plane VCN 1118, and DB subnet(s) 1130 contained in the data plane data tier 1150. The untrusted app subnet(s) 1162 can be communicatively coupled to the service gateway 1136 contained in the data plane VCN 1118 and DB subnet(s) 1130 contained in the data plane data tier 1150. The data plane data tier 1150 can include DB subnet(s) 1130 that can be communicatively coupled to the service gateway 1136 contained in the data plane VCN 1118.

The untrusted app subnet(s) 1162 can include primary VNICs 1164(1)−(N) that can be communicatively coupled to tenant virtual machines (VMs) 1166(1)−(N) residing within the untrusted app subnet(s) 1162. Each tenant VM 1166(1)−(N) can run code in a respective container 1167(1)−(N), and be communicatively coupled to an app subnet 1126 that can be contained in a data plane app tier 1146 that can be contained in a container egress VCN 1168. Respective secondary VNICs 1172(1)−(N) can facilitate communication between the untrusted app subnet(s) 1162 contained in the data plane VCN 1118 and the app subnet contained in the container egress VCN 1168. The container egress VCN can include a NAT gateway 1138 that can be communicatively coupled to public Internet 1154 (e.g., public Internet 854 of FIG. 8).

The Internet gateway 1134 contained in the control plane VCN 1116 and contained in the data plane VCN 1118 can be communicatively coupled to a metadata management service 1152 (e.g., the metadata management system 852 of FIG. 8) that can be communicatively coupled to public Internet 1154. Public Internet 1154 can be communicatively coupled to the NAT gateway 1138 contained in the control plane VCN 1116 and contained in the data plane VCN 1118. The service gateway 1136 contained in the control plane VCN 1116 and contained in the data plane VCN 1118 can be communicatively coupled to cloud services 1156.

In some examples, the pattern illustrated by the architecture of block diagram 1100 of FIG. 11 may be considered an exception to the pattern illustrated by the architecture of block diagram 1000 of FIG. 10 and may be desirable for a customer of the IaaS provider if the IaaS provider cannot directly communicate with the customer (e.g., a disconnected region). The respective containers 1167(1)−(N) that are contained in the VMs 1166(1)−(N) for each customer can be accessed in real-time by the customer. The containers 1167(1)−(N) may be configured to make calls to respective secondary VNICs 1172(1)−(N) contained in app subnet(s) 1126 of the data plane app tier 1146 that can be contained in the container egress VCN 1168. The secondary VNICs 1172(1)−(N) can transmit the calls to the NAT gateway 1138 that may transmit the calls to public Internet 1154. In this example, the containers 1167(1)−(N) that can be accessed in real-time by the customer can be isolated from the control plane VCN 1116 and can be isolated from other entities contained in the data plane VCN 1118. The containers 1167(1)−(N) may also be isolated from resources from other customers.

In other examples, the customer can use the containers 1167(1)−(N) to call cloud services 1156. In this example, the customer may run code in the containers 1167(1)−(N) that requests a service from cloud services 1156. The containers 1167(1)−(N) can transmit this request to the secondary VNICs 1172(1)−(N) that can transmit the request to the NAT gateway that can transmit the request to public Internet 1154. Public Internet 1154 can transmit the request to LB subnet(s) 1122 contained in the control plane VCN 1116 via the Internet gateway 1134. In response to determining the request is valid, the LB subnet(s) can transmit the request to app subnet(s) 1126 that can transmit the request to cloud services 1156 via the service gateway 1136.

It should be appreciated that IaaS architectures 800, 900, 1000, 1100 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In some embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

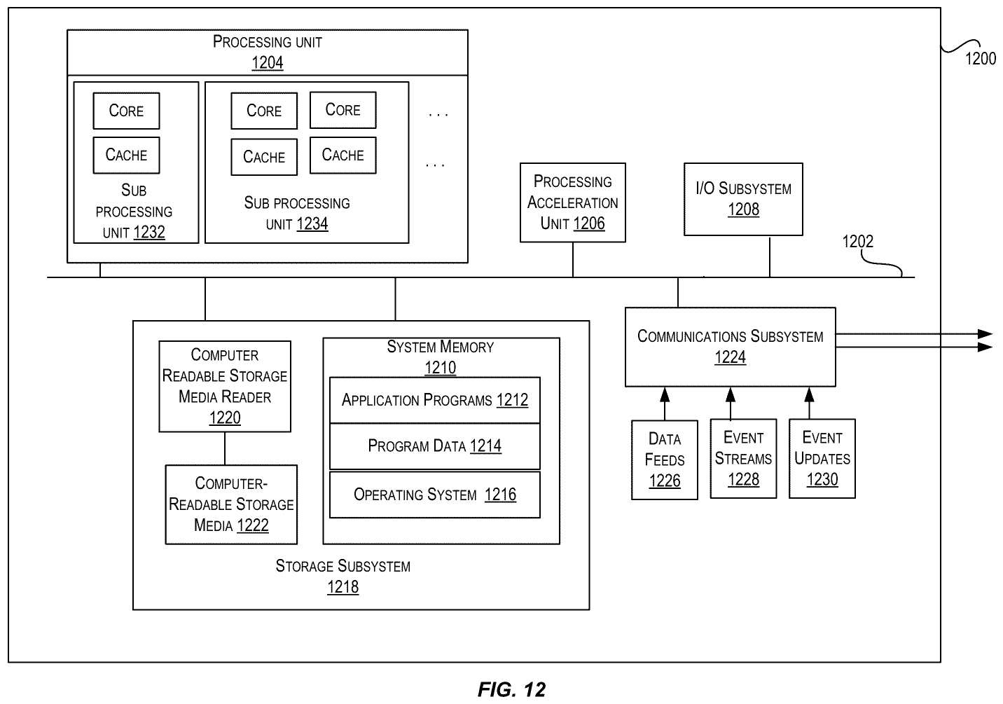

FIG. 12 illustrates an example computer system 1200, in which various embodiments may be implemented. The system 1200 may be used to implement any of the computer systems described above. As shown in the figure, computer system 1200 includes a processing unit 1204 that communicates with a number of peripheral subsystems via a bus subsystem 1202. These peripheral subsystems may include a processing acceleration unit 1206, an I/O subsystem 1208, a storage subsystem 1218 and a communications subsystem 1224. Storage subsystem 1218 includes tangible computer-readable storage media 1222 and a system memory 1210.

Bus subsystem 1202 provides a mechanism for letting the various components and subsystems of computer system 1200 communicate with each other as intended. Although bus subsystem 1202 is shown schematically as a single bus, alternative embodiments of the bus subsystem may utilize multiple buses. Bus subsystem 1202 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1204, which can be implemented as one or more integrated circuits (e.g., a conventional microprocessor or microcontroller), controls the operation of computer system 1200. One or more processors may be included in processing unit 1204. These processors may include single core or multicore processors. In some embodiments, processing unit 1204 may be implemented as one or more independent processing units 1232 and/or 1234 with single or multicore processors included in each processing unit. In other embodiments, processing unit 1204 may also be implemented as a quad-core processing unit formed by integrating two dual-core processors into a single chip.

In various embodiments, processing unit 1204 can execute a variety of programs in response to program code and can maintain multiple concurrently executing programs or processes. At any given time, some or all of the program code to be executed can be resident in processor(s) 1204 and/or in storage subsystem 1218. Through suitable programming, processor(s) 1204 can provide various functionalities described above. Computer system 1200 may additionally include a processing acceleration unit 1206, which can include a digital signal processor (DSP), a special-purpose processor, and/or the like.

I/O subsystem 1208 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1200 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1200 may comprise a storage subsystem 1218 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1204 provide the functionality described above. Storage subsystem 1218 may also provide a repository for storing data used in accordance with the present disclosure.

With respect to the example in FIG. 12, storage subsystem 1218 can include various components including a system memory 1210, computer-readable storage media 1222, and a computer readable storage media reader 1220. System memory 1210 may store program instructions that are loadable and executable by processing unit 1204. System memory 1210 may also store data that is used during the execution of the instructions and/or data that is generated during the execution of the program instructions. Various different kinds of programs may be loaded into system memory 1210 including but not limited to client applications, Web browsers, mid-tier applications, relational database management systems (RDBMS), virtual machines, containers, etc.

System memory 1210 may also store an operating system 1216. Examples of operating system 1216 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1200 executes one or more virtual machines, the virtual machines along with their guest operating systems (GOSs) may be loaded into system memory 1210 and executed by one or more processors or cores of processing unit 1204.

System memory 1210 can come in different configurations depending upon the type of computer system 1200. For example, system memory 1210 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1210 may include a basic input/output system (BIOS) containing basic routines that help to transfer information between elements within computer system 1200, such as during start-up.

Computer-readable storage media 1222 may represent remote, local, fixed, and/or removable storage devices plus storage media for temporarily and/or more permanently containing, storing, computer-readable information for use by computer system 1200 including instructions executable by processing unit 1204 of computer system 1200.

Computer-readable storage media 1222 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1222 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1222 may include, but is not limited to, Zip® drives, flash memory cards, universal serial bus (USB) flash drives, secure digital (SD) cards, DVD disks, digital video tape, and the like. Computer-readable storage media 1222 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1200.

Machine-readable instructions executable by one or more processors or cores of processing unit 1204 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1224 provides an interface to other computer systems and networks. Communications subsystem 1224 serves as an interface for receiving data from and transmitting data to other systems from computer system 1200. For example, communications subsystem 1224 may enable computer system 1200 to connect to one or more devices via the Internet. In some embodiments communications subsystem 1224 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 1224 can provide wired network connectivity (e.g., Ethernet) in addition to or instead of a wireless interface.

In some embodiments, communications subsystem 1224 may also receive input communication in the form of structured and/or unstructured data feeds 1226, event streams 1228, event updates 1230, and the like on behalf of one or more users who may use computer system 1200.

By way of example, communications subsystem 1224 may be configured to receive data feeds 1226 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1224 may also be configured to receive data in the form of continuous data streams, which may include event streams 1228 of real-time events and/or event updates 1230, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1224 may also be configured to output the structured and/or unstructured data feeds 1226, event streams 1228, event updates 1230, and the like to one or more databases that may be in communication with one or more streaming data source computers coupled to computer system 1200.

Computer system 1200 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1200 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that some embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method comprising:
generating a request payload having a common request body specification based on an utterance, wherein the common request body specification is a standardized data input format used by a generative artificial intelligence (GenAI) interface for interacting with a plurality of GenAI model providers;
converting the common request body specification into a custom request body specification having a data input format associated with a GenAI model provider selected from the plurality of GenAI model providers;
communicating, by the GenAI interface, the request payload with the custom request body specification to the GenAI provider for processing by a GenAI model;
receiving, at the GenAI interface from the GenAI model provider, a response payload associated with: (i) an error, (ii) processing the request payload, or (iii) both;
generating a custom response body specification associated with the response payload, wherein the custom response body specification has a data output format associated with the GenAI model provider;
converting the custom response body specification into a common response body specification, wherein the common response body specification is a standardized data output format used by the GenAI interface for interacting with the plurality of GenAI model providers;
determining whether the response payload includes an error or invalid data based on an evaluation of the common response body specification; and
responsive to determining whether the response payload includes an error or invalid data, (i) executing one or more actions for handling the error or invalid data when the response payload includes the error or invalid data, or (ii) executing one or more other actions for processing the response payload when the response payload does not include the error or invalid data.

2. The computer-implemented method of claim 1, wherein determining whether the response payload includes an error or invalid data comprises generating, by another artificial intelligence model, information concerning presence or absence of the error or invalid data within the common response body specification, wherein the generating is performed by: (i) retrieving information from one or more authoritative external sources to confirm accuracy of the response payload, (ii) assessing whether the response maintains contextual integrity, ensuring that the response payload is appropriate and relevant within a given context, (iii) identifying errors or inconsistencies in the response payload based on a list of errors or inconsistencies, (iv) generating a reasoning chain or step-by-step explanation and validating whether the response payload follows the reasoning or explanation, or any combination thereof.

3. The computer-implemented method of claim 1, wherein determining whether the response payload includes an error or invalid data comprises:
comparing values for entities with data in the response payload;
evaluating, based on the comparing, whether there any missing matches between the values for the entities and the data in the response payload; and
responsive to determining there are missing matches, determining whether the missing matches are indicative of the error or invalid data.

4. The computer-implemented method of claim 3, wherein executing the one or more actions comprises:
modifying the request payload based on the error or invalid data to generate a modified request payload, wherein the modified request payload includes an instruction that informs the GenAI model provider, the GenAI model, or both of the missing matches and requests that the GenAI model provider, the GenAI model, or both to revise the response payload to include the values for the entities associated with missing matches; and
communicating the modified request payload to the GenAI model provider for processing by the GenAI model.

5. The computer-implemented method of claim 1, further comprising:
determining whether the request payload includes an error or invalid data based on an evaluation of the common request body specification; and
responsive to determining whether the request payload includes an error or invalid data, (i) executing one or more actions for handling the error or invalid data when the request payload includes the error or invalid data, or (ii) converting the common request body specification into the custom request body when the request payload does not include the error or invalid data.

6. The computer-implemented method of claim 1, wherein executing the one or more actions comprises:
modifying the request payload based on the error or invalid data to generate a modified request payload, wherein the modified request payload includes an instruction that informs the GenAI model provider, the GenAI model, or both of the error or invalid data and requests that the GenAI model provider, the GenAI model, or both correct the error or invalid data; and
communicating the modified request payload to the GenAI model provider for processing by the GenAI model.

7. The computer-implemented method of claim 1, wherein executing the one or more actions comprises:
modifying the response payload based on the error or invalid data to generate a modified response payload, wherein the modified response payload includes and instruction that informs the GenAI model provider, the GenAI model, or both of the error or invalid data and requests that the GenAI model provider, the GenAI model, or both correct the error or invalid data; and
communicating the modified prompt to the GenAI model provider for processing by the GenAI model.

8. The computer-implemented method of claim 1, wherein:
generating the request payload having the common request body specification, comprises representing the utterance as one or more messages based on JavaScript object syntax (JSON); and
generating the custom response body specification associated with the response payload, comprises representing the response payload as one or more candidate messages or a set of candidate messages based on JSON.

9. A system comprising:
one or more processors; and
one or more computer-readable media storing instructions which, when executed by the one or more processors, cause the system to perform operations comprising:
generating a request payload having a common request body specification based on an utterance, wherein the common request body specification is a standardized data input format used by a generative artificial intelligence (GenAI) interface for interacting with a plurality of GenAI model providers;
converting the common request body specification into a custom request body specification having a data input format associated with a GenAI model provider selected from the plurality of GenAI model providers;
communicating, by the GenAI interface, the request payload with the custom request body specification to the GenAI provider for processing by a GenAI model;
receiving, at the GenAI interface from the GenAI model provider, a response payload associated with: (i) an error, (ii) processing the request payload, or (iii) both;
generating a custom response body specification associated with the response payload, wherein the custom response body specification has a data output format associated with the GenAI model provider;
converting the custom response body specification into a common response body specification, wherein the common response body specification is a standardized data output format used by the GenAI interface for interacting with the plurality of GenAI model providers;
determining whether the response payload includes an error or invalid data based on an evaluation of the common response body specification; and
responsive to determining whether the response payload includes an error or invalid data, (i) executing one or more actions for handling the error or invalid data when the response payload includes the error or invalid data, or (ii) executing one or more other actions for processing the response payload when the response payload does not include the error or invalid data.

10. The system of claim 9, wherein determining whether the response payload includes an error or invalid data comprises generating, by another artificial intelligence model, information concerning presence or absence of the error or invalid data within the common response body specification, wherein the generating is performed by: (i) retrieving information from one or more authoritative external sources to confirm accuracy of the response payload, (ii) assessing whether the response maintains contextual integrity, ensuring that the response payload is appropriate and relevant within a given context, (iii) identifying errors or inconsistencies in the response payload based on a list of errors or inconsistencies, (iv) generating a reasoning chain or step-by-step explanation and validating whether the response payload follows the reasoning or explanation, or any combination thereof.

11. The system of claim 9, wherein determining whether the response payload includes an error or invalid data comprises:
comparing values for entities with data in the response payload;
evaluating, based on the comparing, whether there any missing matches between the values for the entities and the data in the response payload; and
responsive to determining there are missing matches, determining whether the missing matches are indicative of the error or invalid data.

12. The system of claim 11, wherein executing the one or more actions comprises:
modifying the request payload based on the error or invalid data to generate a modified request payload, wherein the modified request payload includes an instruction that informs the GenAI model provider, the GenAI model, or both of the missing matches and requests that the GenAI model provider, the GenAI model, or both to revise the response payload to include the values for the entities associated with missing matches; and
communicating the modified request payload to the GenAI model provider for processing by the GenAI model.

13. The system of claim 9, wherein the operations further comprise:
determining whether the request payload includes an error or invalid data based on an evaluation of the common request body specification; and
responsive to determining whether the request payload includes an error or invalid data, (i) executing one or more actions for handling the error or invalid data when the request payload includes the error or invalid data, or (ii) converting the common request body specification into the custom request body when the request payload does not include the error or invalid data.

14. The system of claim 9, wherein executing the one or more actions comprises:
modifying the request payload based on the error or invalid data to generate a modified request payload, wherein the modified request payload includes an instruction that informs the GenAI model provider, the GenAI model, or both of the error or invalid data and requests that the GenAI model provider, the GenAI model, or both correct the error or invalid data; and
communicating the modified request payload to the GenAI model provider for processing by the GenAI model.

15. The system of claim 9, wherein executing the one or more actions comprises:
modifying the response payload based on the error or invalid data to generate a modified response payload, wherein the modified response payload includes and instruction that informs the GenAI model provider, the GenAI model, or both of the error or invalid data and requests that the GenAI model provider, the GenAI model, or both correct the error or invalid data; and
communicating the modified prompt to the GenAI model provider for processing by the GenAI model.

16. One or more non-transitory computer-readable media storing instructions which, when executed by one or more processors, cause the one or more processors to perform operations comprising:
generating a request payload having a common request body specification based on an utterance, wherein the common request body specification is a standardized data input format used by a generative artificial intelligence (GenAI) interface for interacting with a plurality of GenAI model providers;
converting the common request body specification into a custom request body specification having a data input format associated with a GenAI model provider selected from the plurality of GenAI model providers;
communicating, by the GenAI interface, the request payload with the custom request body specification to the GenAI provider for processing by a GenAI model;
receiving, at the GenAI interface from the GenAI model provider, a response payload associated with: (i) an error, (ii) processing the request payload, or (iii) both;
generating a custom response body specification associated with the response payload, wherein the custom response body specification has a data output format associated with the GenAI model provider;
converting the custom response body specification into a common response body specification, wherein the common response body specification is a standardized data output format used by the GenAI interface for interacting with the plurality of GenAI model providers;
determining whether the response payload includes an error or invalid data based on an evaluation of the common response body specification; and
responsive to determining whether the response payload includes an error or invalid data, (i) executing one or more actions for handling the error or invalid data when the response payload includes the error or invalid data, or (ii) executing one or more other actions for processing the response payload when the response payload does not include the error or invalid data.

17. The non-transitory computer-readable media of claim 16, wherein determining whether the response payload includes an error or invalid data comprises generating, by another artificial intelligence model, information concerning presence or absence of the error or invalid data within the common response body specification, wherein the generating is performed by: (i) retrieving information from one or more authoritative external sources to confirm accuracy of the response payload, (ii) assessing whether the response maintains contextual integrity, ensuring that the response payload is appropriate and relevant within a given context, (iii) identifying errors or inconsistencies in the response payload based on a list of errors or inconsistencies, (iv) generating a reasoning chain or step-by-step explanation and validating whether the response payload follows the reasoning or explanation, or any combination thereof.

18. The non-transitory computer-readable media of claim 16, wherein determining whether the response payload includes an error or invalid data comprises:
comparing values for entities with data in the response payload;
evaluating, based on the comparing, whether there any missing matches between the values for the entities and the data in the response payload; and
responsive to determining there are missing matches, determining whether the missing matches are indicative of the error or invalid data.

19. The non-transitory computer-readable media of claim 18, wherein executing the one or more actions comprises:
modifying the request payload based on the error or invalid data to generate a modified request payload, wherein the modified request payload includes an instruction that informs the GenAI model provider, the GenAI model, or both of the missing matches and requests that the GenAI model provider, the GenAI model, or both to revise the response payload to include the values for the entities associated with missing matches; and
communicating the modified request payload to the GenAI model provider for processing by the GenAI model.

20. The non-transitory computer-readable media of claim 16, further comprising:
determining whether the request payload includes an error or invalid data based on an evaluation of the common request body specification; and
responsive to determining whether the request payload includes an error or invalid data, (i) executing one or more actions for handling the error or invalid data when the request payload includes the error or invalid data, or (ii) converting the common request body specification into the custom request body when the request payload does not include the error or invalid data.
